(19) United States
(12) Patent Application Publication
(10) Pub. No.: US 2006/0193318 A1
(43) Pub. Date: Aug. 31, 2006

(54) Method and apparatus for processing inbound and outbound quanta of data

(76) Inventors: Sriram Narasimhan, Cupertino, CA (US); Michael R. Krause, Boulder Creek, CA (US); Gunneswara Marripudi, Santa Clara, CA (US); Ashok Rajogopalan, Santa Clara, CA (US); Sesidhar Baddela, Santa Clara, CA (US); Santosh Rao, Santa Clara, CA (US); Fred B. Worley, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/258,539

(22) Filed: Oct. 24, 2005

Related U.S. Application Data
(60) Provisional application No. 60/657,481, filed on Feb. 28, 2005.

(51) Int. Cl. H04L 12/56

(52) U.S. Cl. 370/389; 370/252

(57) ABSTRACT

A method for processing inbound and/or outbound data wherein a processing policy is determined for a quantum of data. A quantum of inbound data is received and a data notification for the received data is prepared. The notification for the quantum of received inbound data is delivered to a processor according to the processing policy. When selecting a quantum of outbound data, an outbound data work request for the outbound data is prepared and delivered to an output unit according to the processing policy.

### RELATED APPLICATIONS

This present application is related to a provisional application Ser. No. 60/657,481 filed on Feb. 28, 2005 entitled “METHOD AND APPARATUS FOR DIRECT RECEPTION OF INBOUND DATA”, by Rajagopalan et al., currently pending, for which the priority date for this application is hereby claimed.

### BACKGROUND

Continued evolution in the computer art has led to many different improvements and innovations. For example, CPU performance typically increases by 50% each year. Communications systems used to interconnect computing nodes have also improved steadily. For example, local area networks are always improving by providing more bandwidth, lower transfer latency and added security features.

In a general sense, a compute node is any computer that can be envisioned. Workstations, network processors and servers are all examples of different forms of a compute node. It should also be appreciated that a compute node (a.k.a. a “node”) can include more than one processor. In fact, a node can include many processors working collectively and thus form a multi-processor environment.

Networking systems have become so advanced that new and exciting applications have emerged. For example, in addition to supporting network storage and clustered computer applications, wide area networks are now used to carry audio programming, video programming and telephony. It should be appreciated that many of these new applications rely on the higher bandwidth and lower latency offered by modern networking infrastructures.

In order to support many of these new applications, modern data networking has adopted old concepts originally developed to support telephony applications. It should also be appreciated that telephony applications have always needed to provide high bandwidth, low-latency and deterministic conveyance of data from one point to another. High-bandwidth and low-latency are only two factors that are required to support telephony and other time-critical data transfers. The ability of a network to provide a deterministic conveyance is also a strong requirement. A service provider needs to have a high level of confidence that data will be conveyed in a deterministic manner. As a result, many telephony networks are structured as synchronous communications systems with extremely rigid data transfer specifications.

In order to support high performance applications in a non-structured data network (e.g., the Internet), the data network needs to provide some of the fundamental capabilities offered by more structured data networks (e.g. a SONET telephony network). The companies that provide high performance networking applications such as, but not limited to audio programming, video programming and telephony still need deterministic conveyance of data, even when the data is propagated through a less structured data network (e.g. the Internet).

One way that a less structured data network can provide deterministic performance with high bandwidth and low latency is to enforce varied levels of preference for different types of data carried by the network. This is so important that service providers enter into contractual agreements that require a certain level of deterministic performance. These contracts are known as service level agreements (SLAs). In order to ensure contractual compliance, the equipment used to convey data from one point to another must be configured in a manner where the requirements of a binding SLA are observed. Up until now, SLAs have been supported by various prioritization schemes for different types of data carried on a data network.

A data network is much more than just the physical medium that connects one node to another. The various nodes that are all connected to each other are just as much a part of the data network as are the communications channels that connect these nodes to each other. When one node needs to convey data to another node, the data may actually traverse a vast structure where various nodes all play a part in passing the data from one point to another.

As a result, the internal structure of a node determines how effectively a data network can convey data from one point to another. Up until now, the demands of higher bandwidth and lower latency have been addressed by employing faster processors with more memory, faster memory and wider internal data paths. Unfortunately, this design philosophy is often thwarted by hardware limitations. At some point, adding more processors to a node and increasing the width of its internal data paths will no longer be a practical means to improve the data carrying performance of a network processor.

One problem with the “bigger-faster” approach to increasing bandwidth is that the processors included in a node are no longer the elements that limit performance. Adding more processors simply does not help when the memory supporting these processors is bandwidth limited. Another problem with this approach to increasing bandwidth and decreasing latency is that the amount of data that flows in and out of a node carries inherent overhead. For example, every time a data packet arrives in a compute node, one of the processors must stop what it is doing and service the incoming data packet. When the data packet is forwarded by a particular node, a processor also needs to manage the transmission of the data packet as outbound data. Typically, a processor is interrupted by an input or output device whenever a data packet needs to be received or sent, respectively. Each of these interrupts causes the processor to engage in a context switch. Each context switch requires that the processor restructure its perspective of the memory and the input/output (I/O) devices it controls. All of this takes time and results in reduced processor performance.

In order to reduce the burden of processing I/O transactions, various means for coping with interrupts and processing data packets have been developed. For example, where a node includes multiple processors, interrupts generated by arriving data packets can be distributed in order to spread the associated processing load amongst the multiple processors. Another means for coping with high-volume I/O activity is that of off-loading protocol processing to an I/O device. Consider, for example, a data network interface card that can process a protocol known as the Transmission Control Protocol/Internet Protocol (TCP/IP). In this situation, the I/O device can receive one or more data packets, examine the information in the data packets and determine what type of action a node processor needs to take in order to service the incoming data packet. As such, the I/O device will only interrupt a node processor once this off-loaded protocol processing has been performed. Yet another technique for improving bandwidth through a processor is to cause a protocol software, which is executed by a node processor to process a protocol connection, to be executed in multiple instantiations. A different instantiation of the protocol software, which is sometimes called a protocol stack, is executed by different processors in a multi-processor node.

These examples of I/O processing techniques have evolved in order to reduce the processing that a particular node processor needs to perform when servicing either an inbound or an outbound data packet. In order to enforce an SLA, these techniques have been augmented with prioritization capabilities. These prioritization capabilities enable preferential treatment of certain types of data packet. For example, Voice over Internet Protocol (VoIP) data is processed before other, lower-priority data packets.

It should now be appreciated that various techniques to improve I/O processing performance can be applied in different elements in a node. For example, an I/O device can be used to process certain aspects of a communications protocol while other levels of a communications protocol continue to be serviced by a node processor as it executes a protocol stack. Although these varied techniques are often used in conjunction, there are some disturbing performance impediments that arise when these various techniques are applied in conjunction with each other.

One problem with distributing performance enhancing mechanisms across various elements in a node is that there is a possibility that each element will apply a different performance enhancing mechanism in isolation. As such, a performance enhancing technique applied in an I/O device may be in conflict with a performance enhancing technique implemented by a node processor. The net effect may not only cancel any benefit, but may actually degrade overall I/O processing performance in a node.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for processing inbound data;

FIG. 1A is a flow diagram that depicts alternative example methods for determining a processing policy;

FIG. 2 is a flow diagram that depicts one alternative example method for determining a processing policy according to a node attribute;

FIGS. 3A and 3B collectively comprises a flow diagram that depicts alternative methods for receiving a node attribute;

FIG. 4 is a flow diagram that depicts one alternative example method for determining a processing policy according to an input device attribute;

FIGS. 5A, 5B and 5C collectively comprise a flow diagram that depicts alternative variations of the present method for receiving an input device attribute;

FIG. 6 is a flow diagram that depicts one alternative example method for determining a processing policy according to a packet attribute;

FIGS. 7A and 7B collectively comprise a flow diagram that depicts alternative variations of the present method for receiving a packet attribute;

FIG. 8 is a flow diagram that depicts alternative illustrative methods for determining a processing policy in various elements of a node;

FIG. 9 is a flow diagram that depicts alternative example methods for determining a processing policy according to sundry computing node attributes;

FIG. 10 is a flow diagram that depicts one alternative method for delivering an inbound data notification to a processor;

FIG. 11 is a flow diagram that depicts one alternative example method for determining an interrupt mechanism;

FIG. 12 is a flow diagram that depicts one alternative example method for determining an interrupt mechanism according to an in-band indicator received in an input device;

FIG. 13 is a flow diagram that depicts one alternative example method for determining an interrupt mechanism according to an in-band indicator received in a node processor;

FIG. 14 is a flow diagram that depicts an alternative method for determining an interrupt mechanism according to a selected notification queue;

FIG. 15 is a flow diagram that depicts an alternative method for interrupting a processor by coalescing interruptible events;

FIG. 16 is a flow diagram that depicts alternative methods for determining a coalescence value;

FIG. 17 is a flow diagram that depicts alternative method for interrupting a processor according to event definitions;

FIG. 18 is a flow diagram that depicts several alternative methods for defining an interruptible event;

FIG. 19 is a flow diagram that depicts one example method for processing outbound data;

FIG. 19A is a flow diagram that depicts alternative methods for determining a processing policy according to various types of attributes;

FIG. 20 is a flow diagram that depicts one example method for determining an output processing policy according to a node attribute;

FIG. 21 is a flow diagram that depicts one alternative method for determining an output processing policy according to an output device attribute;

FIG. 21A is a flow diagram that depicts one alternative method for determining a processing policy according to a packet attribute;

FIG. 22 is a flow diagram that depicts alternative methods for determining a processing policy in an output processing system;

FIG. 23 is a flow diagram that depicts alternative methods for determining an output processing policy by means of a received policy function;

FIG. 24 is flow diagram that depicts one alternative example method for delivering an outbound work request to an output device;

FIG. 25 is flow diagram that depicts one example variation of the present method for determining an interrupt mechanism for outbound data according to an in-band priority level indicator;

FIG. 26 is a flow diagram that depicts one alternative method for determining an interrupt mechanism based on a work queue;

FIG. 27 is a flow diagram that depicts variations in the present method applicable to coalescing interrupts while processing a quantum of outbound data;

FIG. 28 is a flow diagram that depicts variations in the present method for defining an interruptible event that are applicable to the processing of a quantum of outbound data;

FIG. 29 is a block diagram that depicts one example embodiment of a system for processing inbound data;

FIG. 30 is a block diagram that depicts several example alternative embodiments of a processing policy unit;

FIG. 31 is a block diagram that depicts one alternative example embodiment of a processing policy unit; and

FIG. 32 is a block diagram that depicts several example alternative embodiments of a processing unit that honors a processing policy.

### DETAILED DESCRIPTION

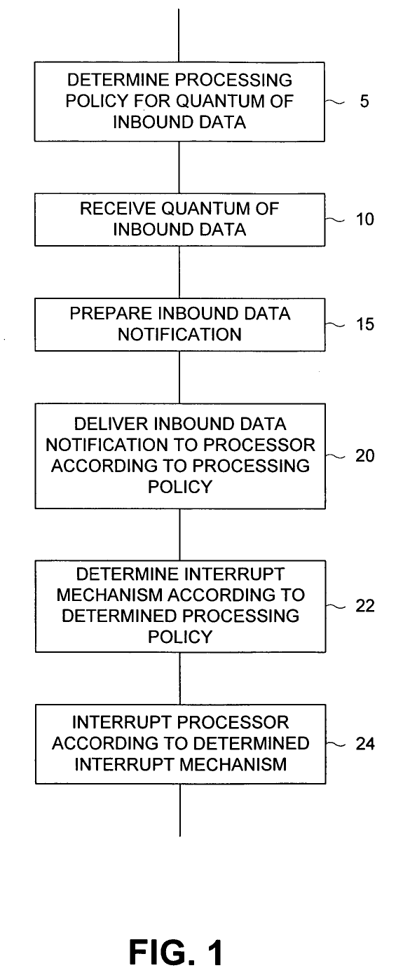

FIG. 1 is a flow diagram that depicts one example method for processing inbound data. According to this example method, in order to receive a quantum of inbound data, a processing policy for receiving the quantum of inbound data is determined (step 5). It should be appreciated that the processing policy, according to this example method, governs the receipt of a quantum of inbound data at every potential level of processing. For example, the processing policy governs the actions of an input device when the input device includes protocol off-loading capabilities. The same processing policy governs the actions of a node processor when it is executing a protocol stack. These are merely examples of various elements in a node and the actions that may be governed by the determined processing policy. Accordingly, the claims appended hereto are not intended to be limited by these examples and applications where the present method is used to govern various actions of these and other elements in a node are intended to be included in the scope claims appended hereto.

Once a processing policy is determined, a quantum of inbound data is received (step 10). An inbound data notification is then prepared (step 15) and delivered to a node processor according to the determined processing policy (step 20). It should be appreciated that a quantum of inbound data, according to one illustrative use case, comprises a data packet. According to yet another illustrative use case, a quantum of inbound data comprises a data byte. It should be appreciated that the scope of the claims appended hereto is to include all various applications of the present method and the actual size or configuration of a quantum of data is not intended to limit the scope of the claims appended hereto.

FIG. 1A is a flow diagram that depicts alternative example methods for determining a processing policy. It should be appreciated that in order to establish a processing policy for an input or an output process, the processing policy that is established needs to consider the attributes of various elements within a processing node. Put simply, the processing policy should not govern the actions of elements in a node without representation of different attributes exhibited by the various elements in the node that are to be governed by the processing policy. For example, a processing node itself will generally exhibit attributes that affect the determination of a processing policy. Accordingly, one variation of the present method provides for determining a processing policy according to a node attribute (step 7). Also, an input device that provides input connectivity to a node will also exhibit attributes that may affect the determination of a processing policy. Accordingly, one variation of the present method provides for determining a processing policy according to an input device attribute (step 13). An output device that provides output connectivity may also affect the determination of a processing policy. Accordingly, one variation of the present method provides for determining a processing policy according to an output device attribute (step 17). A processing policy may also need to be adjusted according to a type of data received into or dispatched from a node. As such, yet another alternative variation of the present method provides for determining a processing policy according to a packet attribute (step 11).

It should be appreciated that any processing policy determined according to various alternative methods herein presented is used to govern the actions of any one of an input device, an output device and a processing unit included in a processing node. It should be further appreciated that any processing policy determined according to various alternative methods set forth herein when can be determined in various elements in a node (e.g. in an input device, an output device and a processing unit). When a processing policy is determined in a distributed manner, facilities are provided to ensure harmonious processing policy determinations amongst various elements in a processing node.

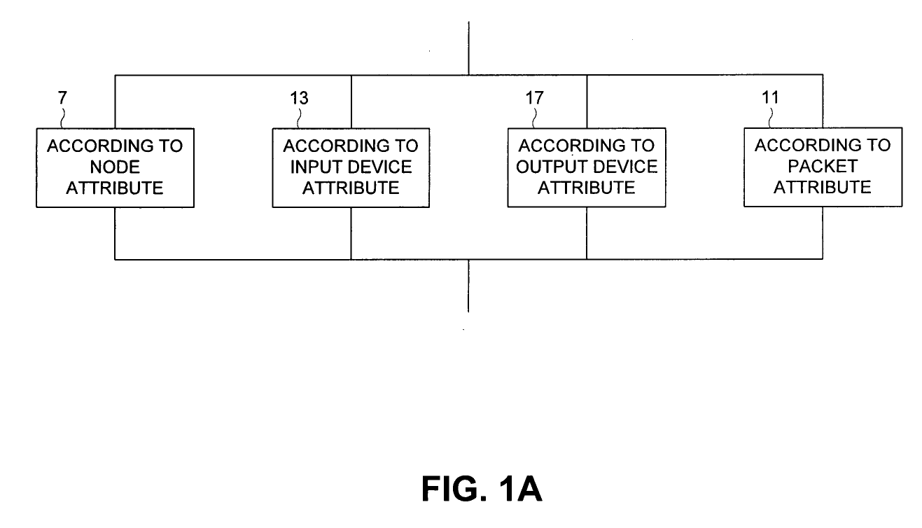

FIG. 2 is a flow diagram that depicts one alternative example method for determining a processing policy according to a node attribute. According to this example variation of the present method, a node attribute is received (step 25). Once the node attribute is received, a notification queue is determined (step 30) according to one variation of the present method. In another variation of the present method, a quality-of-service indicator is determined (step 35) according to the received node attribute.

According to one variation of the present method, once an inbound data notification is prepared for a quantum of inbound data, it is delivered to a processor by posting the inbound data notification in a notification queue. Accordingly, this variation of the present method for determining a processing policy determines which notification queue an inbound data notification should be posted to according to a received node attribute. According to yet another variation of the present method, a processor is notified of an inbound data packet by means of an interrupt. As such, the quality-of-service indicator determined according to a received node attribute is used to determine a priority level at which a processor is interrupted. According to yet another variation of the present method, the quality-of-service indicator is used to select an interrupt coalescing scheme, which can be used to reduce the number of interrupts presented to a processor over a particular interval of time.

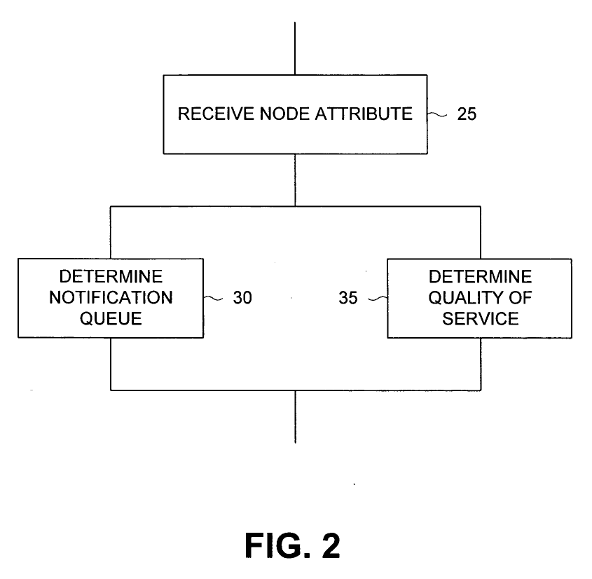

FIGS. 3A and 3B collectively comprises a flow diagram that depicts alternative methods for receiving a node attribute. Various node attributes, according to various alternative methods, affect the determination of a processing policy either individually, collectively or in any combination.

As such, one variation of the present method provides for receiving a processor task assignment (step 40) as a node attribute. An assignment of a particular task to a particular processor, according to this variation of the present method, is used as one of one or more factors in either selecting a notification queue or determining a quality of service.

Another example variation of the present method provides for receiving a processor task (i.e. a process) priority indicator (step 45) as a node attribute. A priority of a particular task executed by a particular processor, according to this variation of the present method, is used as one of one or more factors in either selecting a notification queue or determining a quality of service.

According to yet another example variation of the present method, an input device location is received (step 50) as a node attribute. The location of a particular input device (e.g. relative to a processor in a bus structure), according to this variation of the present method, is used as one of one or more factors in either selecting a notification queue or determining a quality of service.

In yet another example variation of the present method, the quantity of processors in a node is received (step 55) as a node attribute. The number of processors in a node, according to this variation of the present method, is used as one of one or more factors in either selecting a notification queue or determining a quality of service.

Another example variation of the present method provides for receiving an indicator that represents the number of processors that are servicing an input device (step 60) as a node attribute. The number of processors servicing an input device, according to this variation of the present method, is used as one of one or more factors in either selecting a notification queue or determining a quality of service.

Another example variation of the present method provides for receiving an indicator that represents the number of processors in a node that are servicing interrupts (step 65) as a node attribute. The number of processors that are servicing interrupts, according to this variation of the present method, is used as one of one or more factors in either selecting a notification queue or determining a quality of service.

According to yet another example variation of the present method, an indicator that reflects whether or not a node supports prioritized interrupts is received (step 70) as a node attribute. According to this variation of the present method, the fact that a node supports prioritized interrupts is used as one of one or more factors in either selecting a notification queue or determining a quality of service.

According to yet another illustrative variation of the present method, an indicator that reflects the pattern of memory access, and the type of a memory location is received as a node attribute. According to this variation of the present method, the memory accessed by the task is used as one of one or more factors in either selecting a notification queue or determining a quality of service.

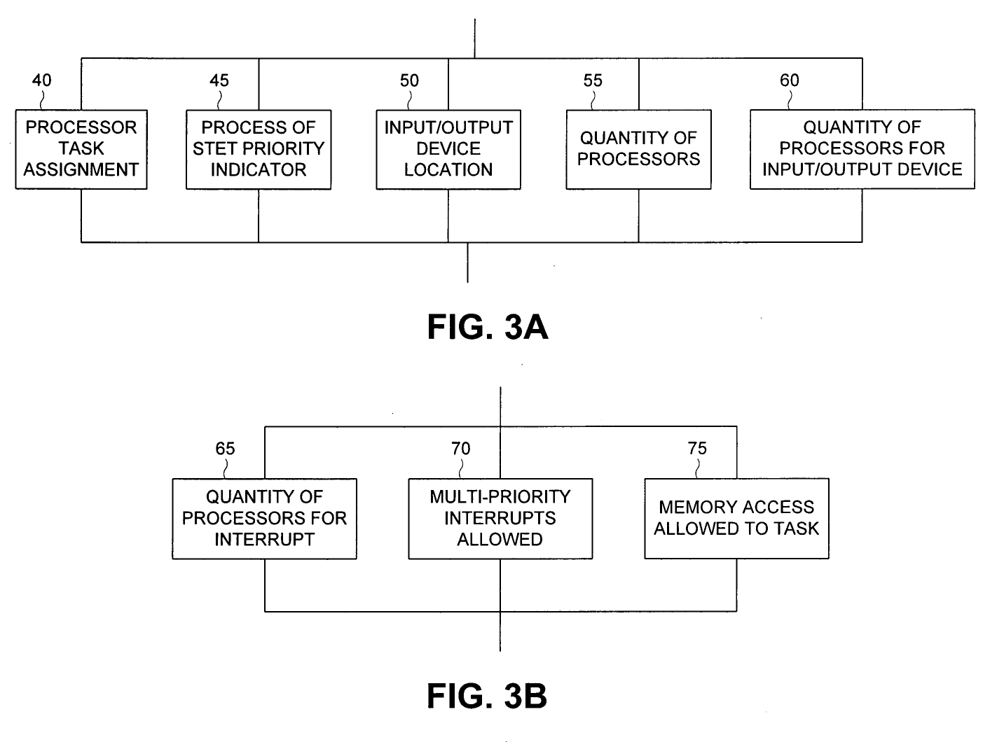

FIG. 4 is a flow diagram that depicts one alternative example method for determining a processing policy according to an input device attribute. According to this example variation of the present method, an input device attribute is received (step 80). Once the input device attribute is received, a notification queue is determined (step 85) according to one illustrative variation of the present method. In another variation of the present method, a quality-of-service indicator is determined (step 90) according to the received input device attribute.

According to one variation of the present method, once an inbound data notification is prepared for a quantum of inbound data, it is delivered to a processor by posting the inbound data notification in a notification queue. Accordingly, this variation of the present method for the notification queue in which the notification is posted is selected according to a received input device attribute. According to yet another variation of the present method, a processor is notified of an inbound data packet by means of an interrupt. As such, the quality-of-service indicator determined according to a received input device attribute is used to determine a priority level at which a processor is interrupted. According to yet another variation of the present method, the quality-of-service indicator is used to select an interrupt coalescing scheme, which can be used to reduce the number of interrupts presented to a processor over a particular interval of time.

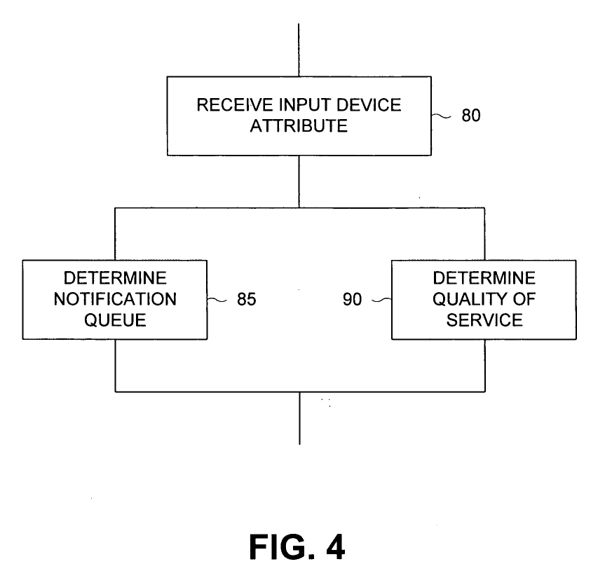

FIGS. 5A, 5B and 5C collectively comprise a flow diagram that depicts alternative variations of the present method for receiving an input device attribute. Various input device attributes, according to various alternative methods, affect the determination of a processing policy either individually, collectively or in any combination.

According to one alternative example variation of the present method, an indicator that reflects the number of notification queues that an input device can post to is received (step 95) as an input device attribute. According to this variation of the present method, the fact that an input device can post a notification to different notification queues or to a particular quantity of notification queues is used as one of one or more factors in either selecting a notification queue or determining a quality of service.

According to one alternative example variation of the present method, an indicator that reflects the type of queue scheduling scheme that an input device supports is received (step 100) as an input device attribute. According to this variation of the present method, the type of queue scheduling schemes that an input device supports is used as one of one or more factors in either selecting a notification queue or determining a quality of service.

According to yet another alternative example variation of the present method, an indicator reflecting the number of processors that an input device can interrupt is received (step 105) as an input device attribute. According to this variation of the present method, the number of processors that an input device can interrupt is used as one of one or more factors in either selecting a notification queue or determining a quality of service.

According to one alternative example variation of the present method, an indicator that reflects the bandwidth that an input device provides is received (step 110) as an input device attribute. According to this variation of the present method, the amount of bandwidth provided by an input device is used as one of one or more factors in either selecting a notification queue or determining a quality of service.

According to one alternative example variation of the present method, an indicator that reflects whether or not an input device provides protocol-off loading capabilities is received (step 115) as an input device attribute. According to this variation of the present method, the ability (or lack thereof) of an input device to provide protocol off-loading is used as one of one or more factors in either selecting a notification queue or determining a quality of service.

According to yet another alternative example variation of the present method, an indicator reflecting an input devices ability to coalesce interrupts is received (step 120) as an input device attribute. According to this variation of the present method, the ability of an input device to coalesce interrupts is used as one of one or more factors in either selecting a notification queue or determining a quality of service.

According to one alternative example variation of the present method, an indicator that reflects the amount of memory an input device provides is received (step 125) as an input device attribute. According to this variation of the present method, the amount of memory an input device provides is used as one of one or more factors in either selecting a notification queue or determining a quality of service.

According to yet another alternative example variation of the present method, an indicator reflecting an input devices ability to embed control information in-line with data is received (step 130) as an input device attribute. According to this variation of the present method, the ability of an input device to receive and/or process in-line control information included with inbound data is used as one of one or more factors in either selecting a notification queue or determining a quality of service.

According to yet another alternative example variation of the present method, an indicator reflecting an input devices ability to support variable-length data in inbound data notifications is received (step 135) as an input device attribute. According to this variation of the present method, the ability of an input device to support variable length data in inbound data notifications is used as one of one or more factors in either selecting a notification queue or determining a quality of service.

In yet another alternative example variation of the present method, an indicator the number of local queues an input device provides is received (step 140) as an input device attribute. According to this variation of the present method, the number of local queues provided by an input device is used as one of one or more factors in either selecting a notification queue or determining a quality of service.

According to yet another alternative example variation of the present method, an indicator reflecting a quantity of how many doorbell resources are provided by an input device is received (step 145) as an input device attribute. According to this variation of the present method, the number of doorbell resources provided by an input device is used as one of one or more factors in either selecting a notification queue or determining a quality of service.

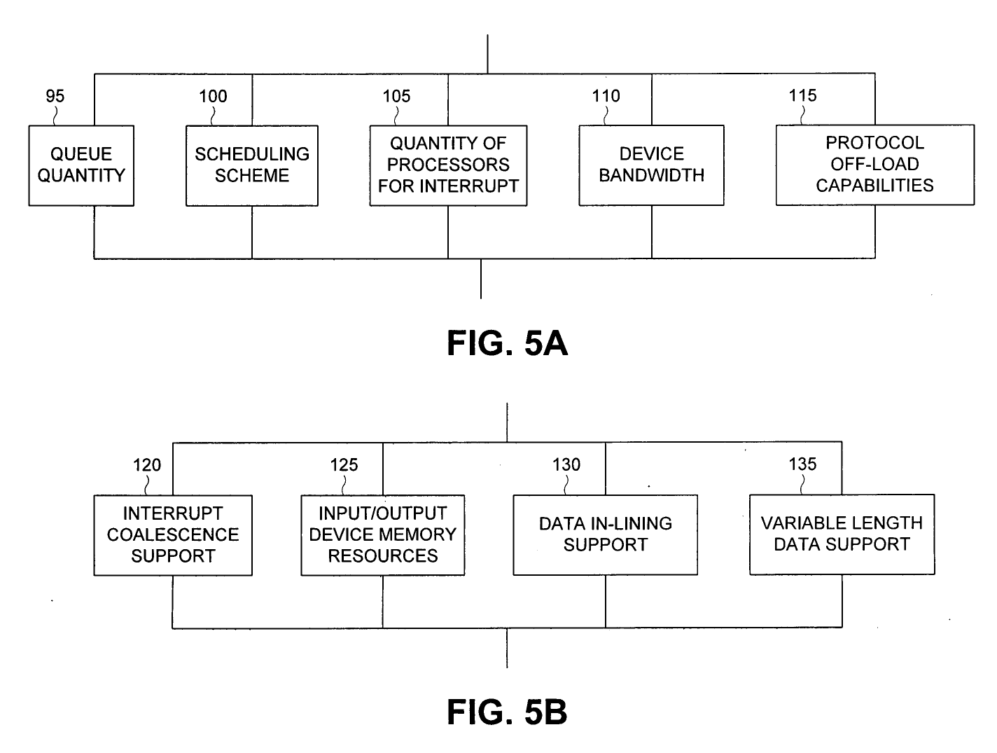

FIG. 6 is a flow diagram that depicts one alternative example method for determining a processing policy according to a packet attribute. According to this example variation of the present method, a packet attribute is received (step 150). Once the packet attribute is received, a notification queue is determined (step 155) according to one variation of the present method. In another variation of the present method, a quality-of-service indicator is determined (step 160) according to the received packet attribute.

According to one variation of the present method, once an inbound data notification is prepared for a quantum of inbound data, it is delivered to a processor by posting the inbound data notification in a notification queue. Accordingly, this variation of the present method, a selection of which notification queue an inbound data notification is posted to is determined according to a received packet attribute. According to yet another variation of the present method, a processor is notified of an inbound data packet by means of an interrupt. As such, the quality-of-service indicator determined according to a received packet attribute is used to determine a priority level at which a processor is interrupted. According to yet another variation of the present method, the quality-of-service indicator is used to select an interrupt coalescing scheme, which can be used to reduce the number of interrupts presented to a processor over a particular interval of time.

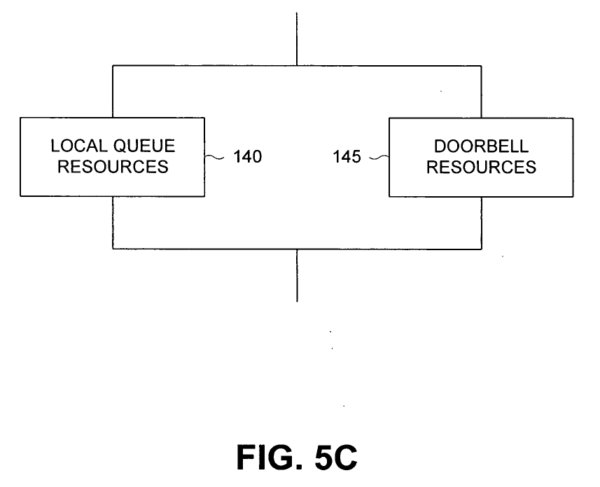

FIGS. 7A and 7B collectively comprise a flow diagram that depicts alternative variations of the present method for receiving a packet attribute. Various packet attributes, according to various alternative methods, affect the determination of a processing policy either individually, collectively or in any combination.

According to yet another alternative example variation of the present method, an indicator reflecting the amount of data transferred during a particular communications connection is received (step 165) as a packet attribute. According to this variation of the present method, the amount of data transferred during a communications connection is used as one of one or more factors in either selecting a notification queue or determining a quality of service.

In yet another alternative example variation of the present method, a content of a link header from a data packet is received (step 170) as a packet attribute. According to this variation of the present method, the content of the link header is used as one of one or more factors in either selecting a notification queue or determining a quality of service.

According to another alternative example variation of the present method, a contents of a network header is received (step 175) as a packet attribute. According to this variation of the present method, the contents of a network header is used as one of one or more factors in either selecting a notification queue or determining a quality of service.

According to another alternative example variation of the present method, a contents of a transport header is received (step 176) as a packet attribute. According to this variation of the present method, the contents of a network header is used as one of one or more factors in either selecting a notification queue or determining a quality of service.

In yet another alternative example variation of the present method, an identifier reflecting a packet grouping is received (step 180) as a packet attribute. According to this variation of the present method, a grouping of data packets, as distinguished by a received packet grouping identifier, is used as one of one or more factors in either selecting a notification queue or determining a quality of service.

According to yet another alternative example variation of the present method, an identifier reflecting an end-point logical packet group is received (step 185) as a packet attribute. According to this variation of the present method, a logical grouping of data packets for an end-point, as distinguished by a received packet grouping identifier, is used as one of one or more factors in either selecting a notification queue or determining a quality of service.

According to another alternative example variation of the present method, an identifier reflecting a multiple end-point logical packet grouping is received (step 190) as a packet attribute. According to this variation of the present method, a logical grouping of data packets for a multiple end-point communications connection, as distinguished by a received packet grouping identifier, is used as one of one or more factors in either selecting a notification queue or determining a quality of service.

According to yet another alternative example variation of the present method, an identifier reflecting a logical packet group of a particular traffic type is received (step 200) as a packet attribute. According to this variation of the present method, a logical grouping of data packets of a particular traffic type, as distinguished by a received packet grouping identifier, is used as one of one or more factors in either selecting a notification queue or determining a quality of service.

According to yet another alternative example variation of the present method, an in-band indicator reflecting the type of traffic carried by a communications connection is received (step 205) as a packet attribute. According to this variation of the present method, the in-band indicator reflecting the type of traffic carried by a communications connection is used as one of one or more factors in either selecting a notification queue or determining a quality of service.

According to one additional alternative example variation of the present method, an in-band indicator reflecting the quality-of-service required by a communications connection is received (step 210) as a packet attribute. According to this variation of the present method, the in-band indicator reflecting the quality-of-service required by a communications connection is used as one of one or more factors in either selecting a notification queue or determining a quality of service.

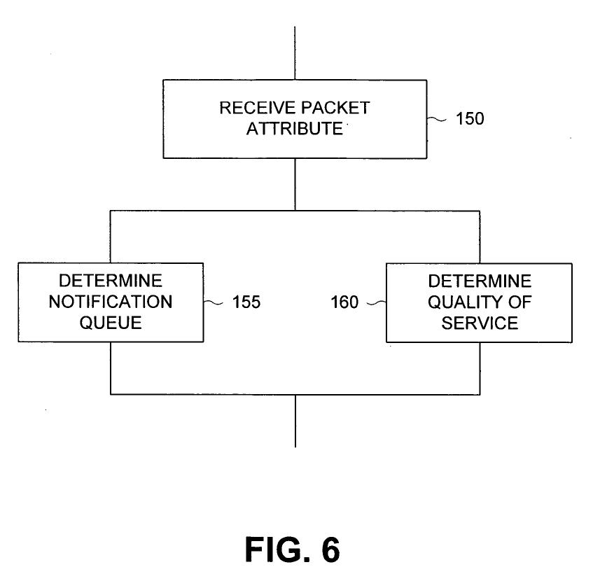

FIG. 8 is a flow diagram that depicts alternative illustrative methods for determining a processing policy in various elements of a node. As already discussed, a processing policy, according to one alternative variation of the present method, is established in an input device (step 215). According to yet another variation of the present method, a processing policy is determined in a processing node (step 220). It should be appreciated that a processing policy can be determined anywhere in a computing node and the scope of the claims appended hereto is not intended to be limited by any examples heretofore described.

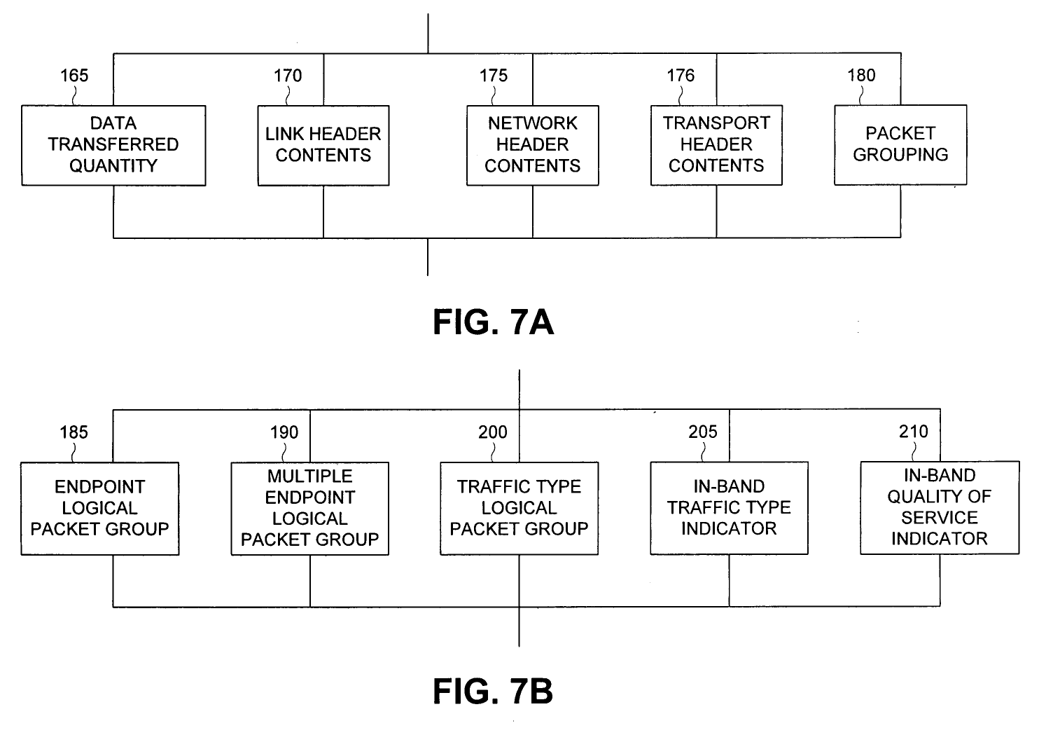

FIG. 9 is a flow diagram that depicts alternative example methods for determining a processing policy according to sundry computing node attributes. It should be appreciated that determining a processing policy, according to one variation of the present method, is accomplished by accepting a quality-of-service attribute (step 225). In this situation, a quality-of-service attribute is directly specified rather than determined according to one or more attributes received from either of a processing node, an input device and a data packet. According to yet another variation of the present method, a processing policy is determined by receiving a notification queue indicator (step 230). It should be appreciated that, according to at least one variation of the present method, a notification queue will be associated with a particular interrupt priority level. Accordingly, by specifying a particular notification queue, an implicit directive is established to use a particular interrupt priority level (i.e. quality of service).

In yet another alternative example variation of the present method, determining a processing policy is accomplished by receiving a work queue to notification queue association indicator (step 235). It should be appreciated that a notification queue, which typically receives notification upon the arrival of a quantum of data, may be associated with a worked queue. The work queue is typically associated with an outbound quantum of data. By specifying a work queue to notification queue association, an implied quality-of-service is determined in that use of a particular work queue or notification queue may result in better performance when a processing thread servicing either of the work queue or the notification queue (which are associated with each other) is executed by a single particular processor in a compute node.

According to yet another illustrative variation of the present method, determination of a processing policy is accomplished by receiving a notification queue to processor binding indicator (step 240). In this situation, an implicit quality-of-service is defined by allowing a notification queue to be serviced by a particular processor in a compute node. Accordingly, the processor to notification queue binding facilitates rapid execution of a processing thread that is servicing an inbound quantum of data where notification of the arrival of this inbound quantum of data is made by posting a notification indicator in the notification queue bound to a particular processor.

In yet another example variation of the present method, a direct priority indicator is received for a notification queue (step 245) as a means of determining a processing policy. In this instance, an interrupt priority level can be specified for a particular notification queue.

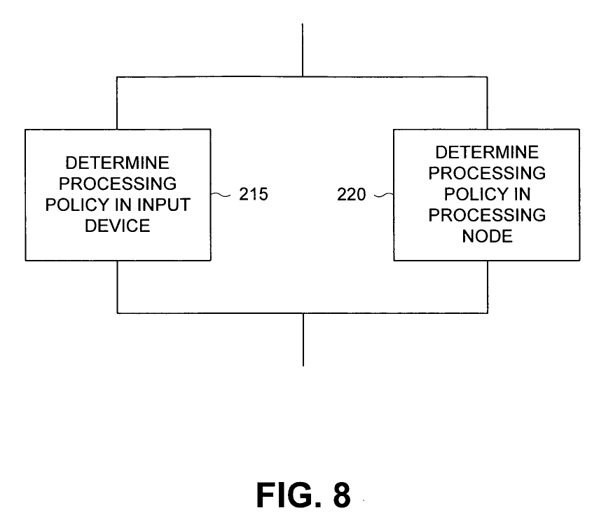

FIG. 10 is a flow diagram that depicts one alternative method for delivering an inbound data notification to a processor. According to this example alternative method, an inbound data notification is delivered to a processor by generating a notification indicator (step 250). The notification indicator, according to various alternative methods, includes information about the inbound data. According to this variation of the present method, a notification queue is selected according to a determined processing policy (step 255). It should be appreciated that a determined processing policy, according to one variation of the present method, includes a notification queue indicator. It is this notification queue indicator that is used to select a particular notification queue. The notification indicator is then posted into the selected notification queue (step 260). Again, the notification queue will accept a notification indicator, which is then processed by a processor at a later point in time.

FIG. 1 further illustrates that, according to one variation of the present method, processing of an inbound quantum of data further comprises determining an interrupt mechanism according to a determined processing policy (step 22). The processor is then interrupted according to the determined interrupt mechanism (step 24).

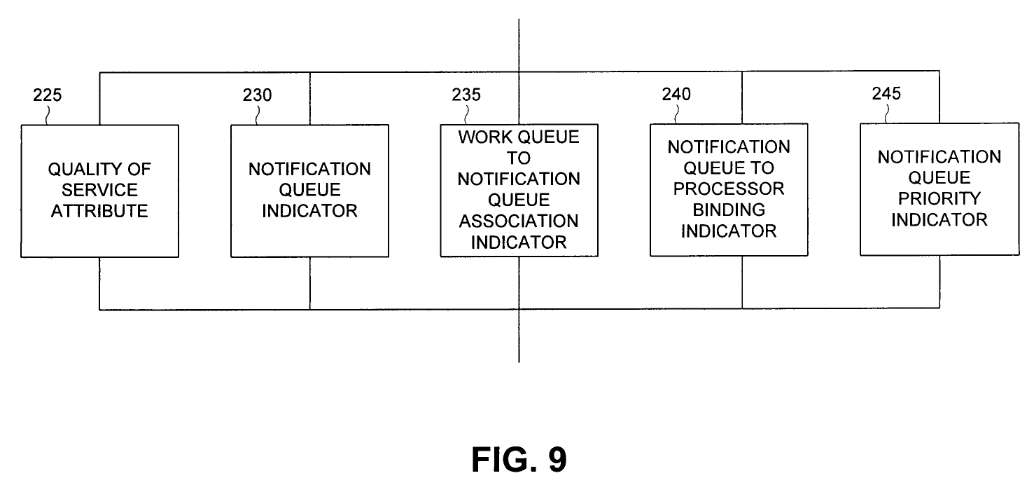

FIG. 11 is a flow diagram that depicts one alternative example method for determining an interrupt mechanism. It should be appreciated that, according to one variation of the present method, determination of a processing policy results in a quality-of-service indicator. This quality-of-service indicator, according to this variation of the present method, is used to determine an interrupt priority mechanism (step 265). It should be further appreciated that the quality-of-service indicator is determined according to at least one of a node attribute, an input device attribute, and a packet attribute. Other sundry compute node attributes, according to yet other variations of the present method, are also used singularly, collectively or in any combination to determine a quality-of-service indicator.

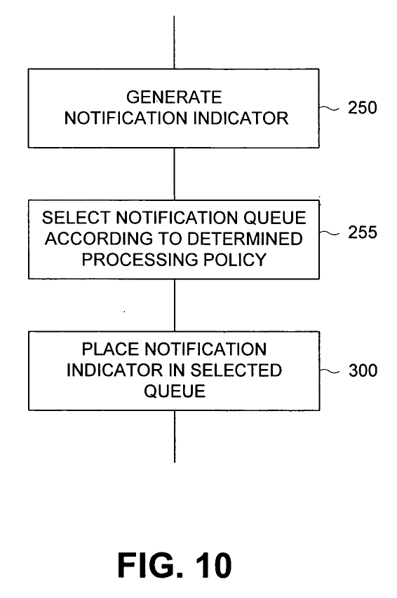

FIG. 12 is a flow diagram that depicts one alternative example method for determining an interrupt mechanism according to an in-band indicator received in an input device. According to this example method, an in-band priority level indicator is received (step 270) in an input device. It should be appreciated that an input device, according to this variation of the present method, receives a quantum of inbound data from a medium (e.g. a network cable). The input device examines the inbound data in order to discover an in-line priority level indicator. When such a priority level indicator is found, it is used to establish a priority level for interrupting a processor (step 275). Typically, the priority level indicator is used to set a priority register in an interrupt controller.

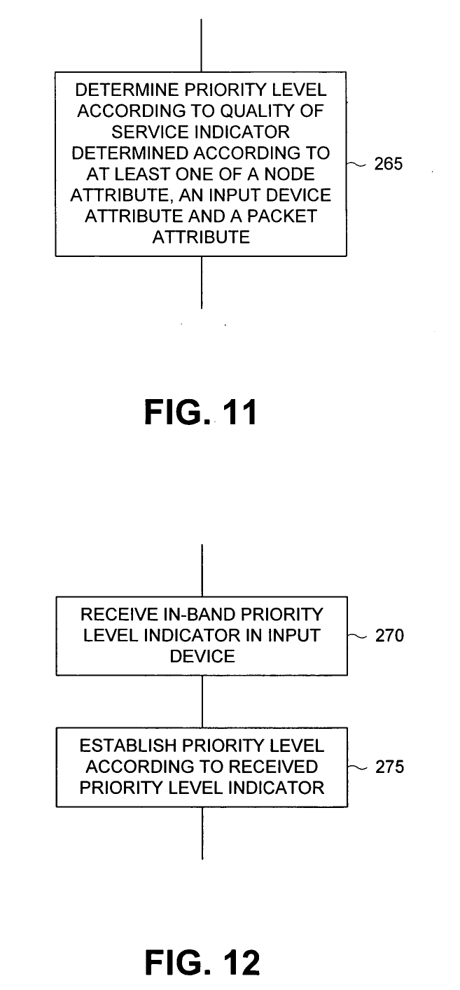

FIG. 13 is a flow diagram that depicts one alternative example method for determining an interrupt mechanism according to an in-band indicator received in a node processor. According to this example method, an in-band priority level indicator is received (step 280) in a node processor. It should be appreciated that a node processor, according to this variation of the present method, receives a quantum of inbound data from an input device. According to one illustrative use case, a node processor receives a quantum of inbound data as it executes a protocol stack. During execution of the protocol stack, the protocol stack will minimally cause the processor to identify an in-band priority level indicator in a quantum of data received from an input device. When such a priority level indicator is found, it is used to establish a priority level for interrupting a processor (step 285). Typically, the priority level indicator is used to set a priority register in an interrupt controller.

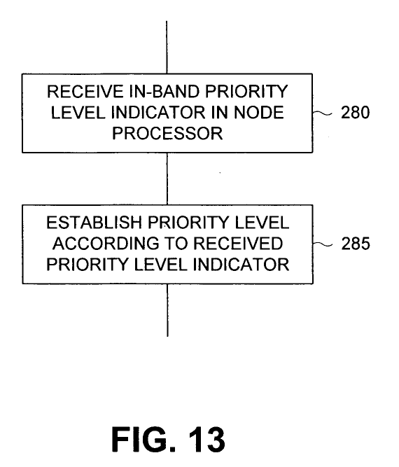

FIG. 14 is a flow diagram that depicts an alternative method for determining an interrupt mechanism according to a selected notification queue. It should be appreciated that one variation of the present method relies on a pre-establish priority level for a particular notification queue. Accordingly, the priority level for a notification queue is determined (step 295). This, according to one variation of the present method, is accomplished by consulting a queue identifier. A queue identifier typically includes a priority level indicator. The priority level indicator for a particular notification queue is then used to establish a priority level for interrupting a processor (step 300). It should be further appreciated that the priority level indicator associated with a particular notification queue is typically used to set a priority register in an interrupt controller.

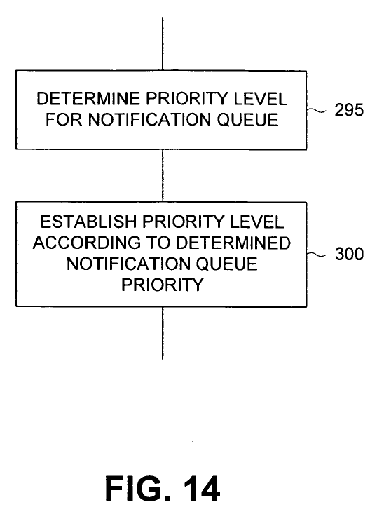

FIG. 15 is a flow diagram that depicts an alternative method for interrupting a processor by coalescing interruptible events. It should be appreciated that variations of this method for coalescing interruptible events are applicable to processing input interrupts and to processing output interrupts. According to this alternative variation of the present method, one or more interruptible events are accumulated (step 305). Also, a coalescence value is determined (step 310). When the number of interruptible events that have been accumulated reaches the coalescence value (step 315), a processor interrupt is generated (step 320). Additional interruptible events continue to be accumulated until the coalescence value is again reached. It should be appreciated that a different coalescence value, according to one variation of the present method, is determined for different types of interruptible events.

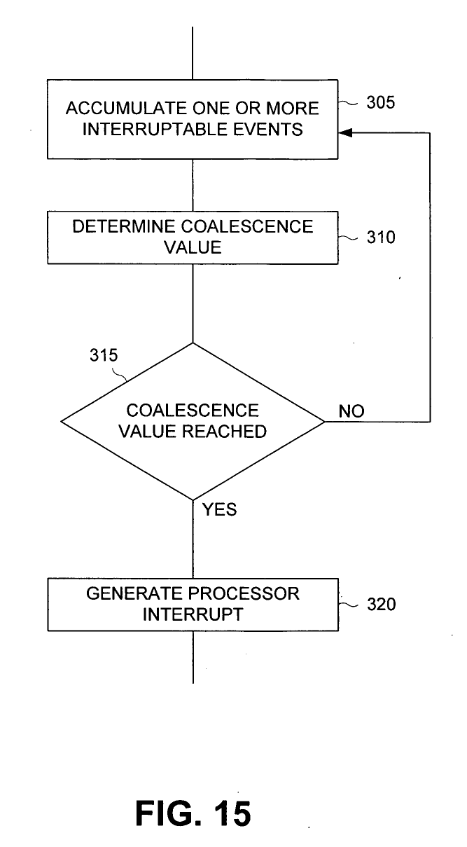

FIG. 16 is a flow diagram that depicts alternative methods for determining a coalescence value. According to one variation of the present method, a coalescence value is determined by determining a link-level frame count (step 325). In this variation of the present method, a link-level frame arriving as inbound data is identified and counted. When the number of link-level frames received reaches the coalescence value (i.e. the link-level frame count coalescence value), a processor interrupt is generated. In yet another variation of the present method, an interrupt latency time (step 330) is established as a coalescence value. In this variation of the present method, the interrupt latency time is used as a maximum value for an interrupt latency time counter. When the interrupt latency time counter meets the interrupt latency time coalescence value, a processor interrupt is generated. According to yet another variation of the present method, an arrived segment count is used as a coalescence value (step 335). In this variation of the present method, protocol segments arriving as inbound data are identified and counted. When the number of protocol segments that have arrived reaches the arrived segment count coalescence value, a processor interrupt is generated. According to yet another example variation of the present method, an arrived byte count is used as a coalescence value (step 340). In this variation of the present method, individual bytes arriving as inbound data are counted. When the number of bytes which have arrived as inbound data reaches the arrived byte count coalescence value, a processor interrupt is generated.

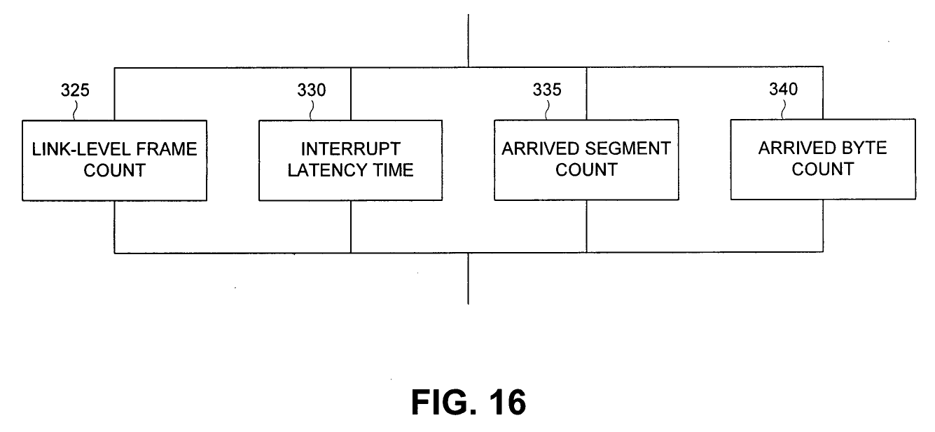

FIG. 17 is a flow diagram that depicts alternative method for interrupting a processor according to event definitions. It should be appreciated that variations of this method for interrupting a processor according to event definitions are applicable to processing input interrupts and to processing output interrupts. According one alternative example method, an interruptible event is defined (step 345). When the defined event occurs (step 350), a processor interrupt is generated (step 355). It should be appreciated that various alternative methods for interrupting a processor rely on different types of interruptible event definitions as more fully described infra.

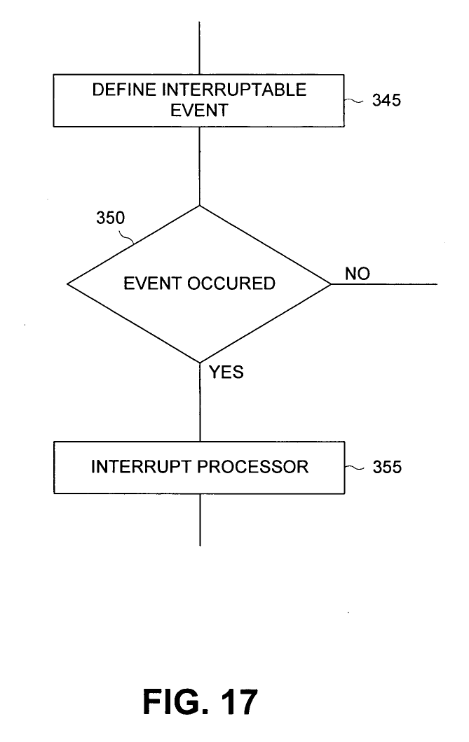

FIG. 18 is a flow diagram that depicts several alternative methods for defining an interruptible event. According to one variation of the present method, the priority of inbound data is defined as an interruptible event (step 360). According to this variation of the present method, when inbound data includes an in-band priority indicator, the in-band priority indicator defines a priority level for the inbound data. An interrupt is generated to a processor when the in-band priority indicator found in the inbound data meets the inbound data priority interruptible event establish according to this variation of the present method. According to yet another variation of the present method, an interruptible event is defined as an input completion event (step 365). According to this variation of the present method, a processor interrupt is generated when a quantum of inbound data has been completely received and/or processed. In yet another variation of the present method, an interruptible event is defined as the receipt of a TCP segment having a push enabled bit set (step 370). Accordingly, a processor interrupt is generated once a TCP segment is received, wherein the received TCP segment includes an active push bit. In yet another variation of the present method, an interruptible event is defined as an input error event (step 375). Accordingly, when an inbound quantum of data exhibits an error either during reception and/or processing, a processor interrupt is generated. In yet another variation of the present method, an interruptible event is defined as an arrived byte mask event (step 380). According to this variation of the present method, one or more byte masks are defined. When a quantum of data includes a byte that matches one of the defined byte masks, a processor interrupt is generated. In yet another variation of the present method, an interruptible event is defined as an arrived header mask (step 385). In this variation of the present method, when a quantum of inbound data includes a header that matches a particular header mask (it should be appreciated that one or more header masks are typically defined according to the present method), a processor interrupt is generated.

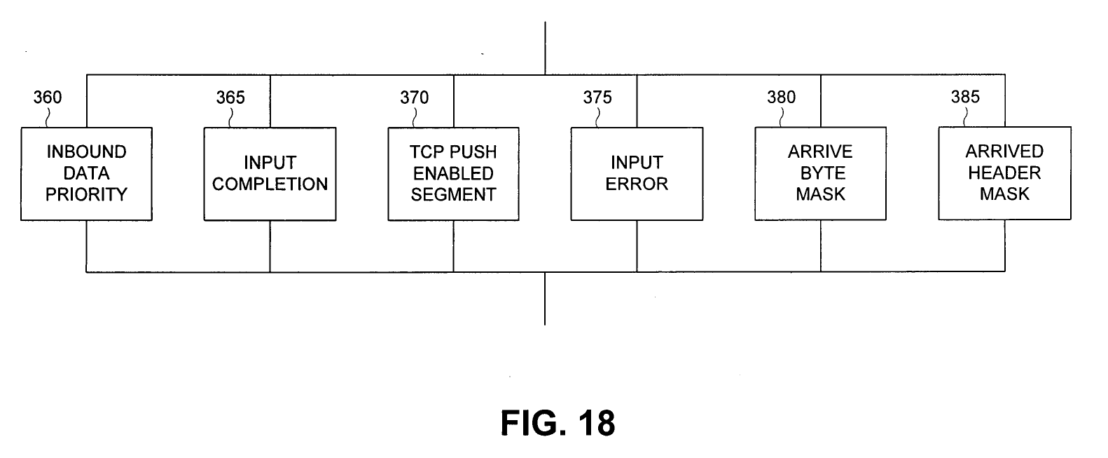

FIG. 19 is a flow diagram that depicts one example method for processing outbound data. According to this example method, outbound data is processed by determining a processing policy for a quantum outbound data (step 400). A quantum of outbound data is then selected (step 405). The outbound data is further processed by preparing an outbound data work request for the quantum of outbound data (step 410). Typically, the work request provides information relative to where the outbound data is to be directed. The work request is then delivered to an output unit according to the determined processing policy (step 415). It should be appreciated that, according to one variation of the present method, the work request is prepared in accordance with the determined processing policy. It should likewise be appreciated that a processing policy determined according to this example method is used to govern the manner in which a quantum of outbound data is processed at various stages in an output processing path. For example, the same processing policy, according to this example method, governs the manner in which a quantum of data is prepared, the way the outbound data is processed in a processing unit, the way a work request is prepared, the way the data is directed to an output unit, the manner in which the output unit processes the data and the manner in which the data is processed in other processing stages. Accordingly, one feature of the present method is that all stages in an output data processing path are governed by a single processing policy. None of the processing stages herein described are intended to limit the scope of the claims appended hereto.

FIG. 19A is a flow diagram that depicts alternative methods for determining a processing policy according to various types of attributes. According to one variation of the present method, a processing policy is determined by receiving a node attribute (step 485). According to yet another variation of the present method, a processing policy is determined by receiving an output device attribute (step 490). In yet another variation of the present method, determining a processing policy is determined by receiving a packet attribute (step 495). Variations of the present method that rely on various types of attributes are described infra.

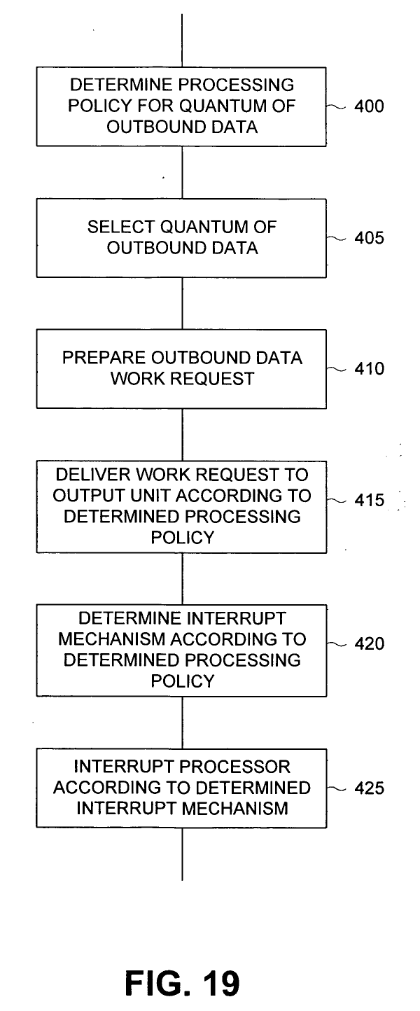

FIG. 20 is a flow diagram that depicts one example method for determining an output processing policy according to a node attribute. According to this example method, a processing policy is determined by receiving a node attribute (step 430). Based on the received node attribute, at least one of a work queue and a quality-of-service attribute are determined (step 435). As already noted, either of a determined work queue and a determined quality-of-service is used at various stages of an output processing path according to one example variation of the present method. FIG. 3A, which has already been introduced, depicts that a node attribute includes at least one of a processor task assignment (step 40), a process priority indicator (step 45), an output device location indicator (step 50), a quantity of processors indicator (step 55), and a quantity of processors assigned to an output device indicator (step 60). FIG. 3B, which has also already been introduced, depicts that a node attribute includes at least one of a quantity of processors allowed for interrupt indicator (step 65), a multi-priority interrupts allowed indicator (step 70) and a memory accessed by task indicator (step 75).

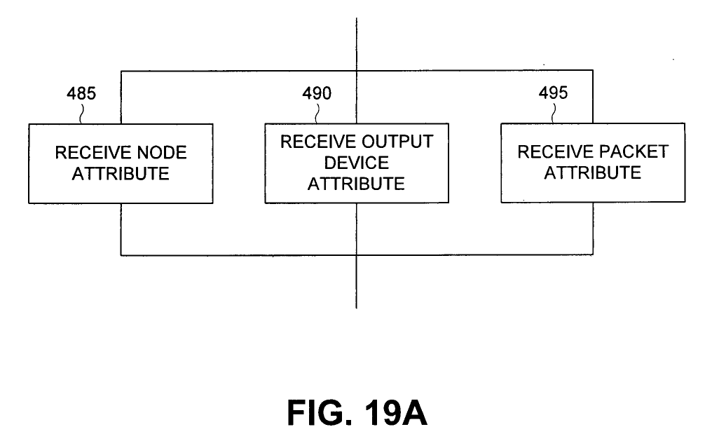

FIG. 21 is a flow diagram that depicts one alternative method for determining an output processing policy according to an output device attribute. According to this alternative method, an output processing policy is determined by receiving an output device attribute (step 440). At least one of a work queue and a quality-of-service attribute is determined according to the output device attribute (step 445). FIGS. 5A and 5B, which have already been introduced, depict various alternative methods for receiving an output device attribute. According to various alternative methods, receiving an output device attribute comprises receiving at least one of a queue quantity indicator (step 95), a queue scheduling scheme indicator (step 100), a quantity of processors available for interrupt indicator (step 105), a device bandwidth indicator (step 110), a protocol off-load capabilities indicator (step 115), an interrupt coalescing support indicator (step 120), an output device memory resource indicator (step 125), a data in-lining support indicator (step 130), a support for variable length data in inbound data notifications indicator (step 135), and a local queue resource indicator (step 140).

FIG. 21A is a flow diagram that depicts one alternative method for determining a processing policy according to a packet attribute. According to this example variation of the present method, a processing policy is determined by receiving a packet attribute (step 441). At least one of a work queue and a quality-of-service attribute is determined according to the received packet attribute (step 446). FIGS. 7A and 7B, which have already been introduced, depict that a packet attribute is received by receiving at least one of a quantity of data transferred indicator (step 165), a contents of a link header (step 170), a contents of a network header (step 175), a contents of a transport header (step 176), a grouping of packets indicator (step 180), a logical grouping of packets based on endpoint indicator (step 185), a logical grouping of packets based on multiple endpoints indicator (step 190), a logical grouping of packets according to traffic type indicator (step 200), an in-band indicator of traffic type (step 205) and an in-band indicator of quality-of-service (step 210).

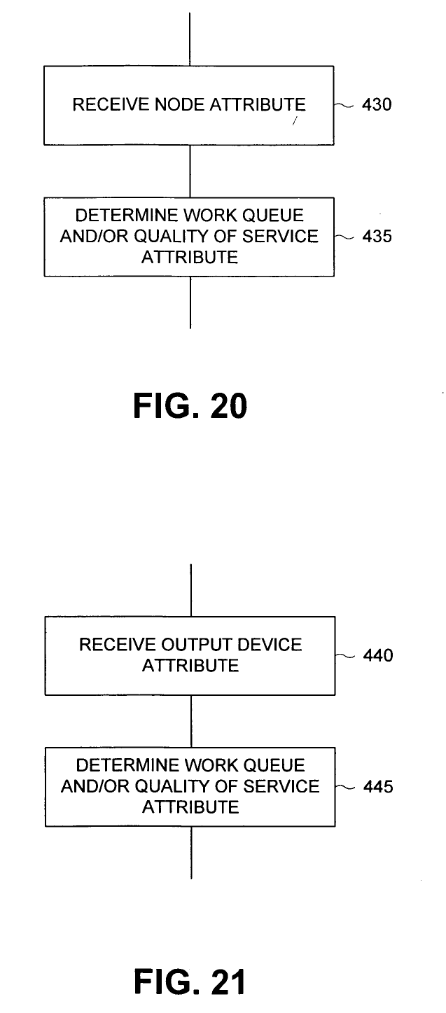

FIG. 22 is a flow diagram that depicts alternative methods for determining a processing policy in an output processing system. According to one variation of the present method, a processing policy is determined in a processing unit (step 450). It should be appreciated that a processing policy, according to this variation of the present method, is determined in a processing unit included in a compute node. The processing policy determined in the processing unit is then shared with an output unit and affects the processing of a quantum of outbound data. According to yet another variation of the present method, a processing policy is determined in the output unit (step 455). In this variation of the present method, a processing policy is determined in the output unit and is then shared with the processing unit. It should be appreciated that a processing policy, according to yet another variation of the present method, is determined outside of either of the processing unit or the output unit and is provided to both the processing unit and the output unit and is used to govern the processing of a quantum of outbound data in the processing unit and in the output unit.

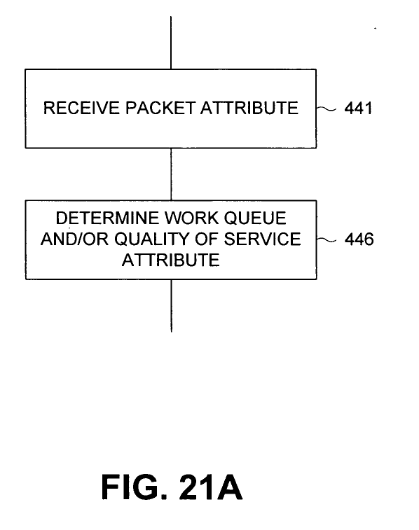

FIG. 23 is a flow diagram that depicts alternative methods for determining an output processing policy by means of a received policy function. According to one example variation of the present method, determining a processing policy is accomplished by receiving a policy function that comprises a quality-of-service attribute (step 460). In yet another illustrative variation of the present method, determining a processing policy is accomplished by receiving a policy function that comprises a work queue indicator (step 465). According to yet another example variation of the present method, determining a processing policy is accomplished by receiving a policy function that comprises a work queue-to-notification queue association indicator (step 470). According to yet another example variation of the present method, determining a processing policy is accomplished by receiving a policy function that comprises a work queue-to-processor binding indicator (step 475). In yet another example variation of the present method, determining a processing policy comprises receiving a policy function that comprises a work queue priority indicator (step 480).

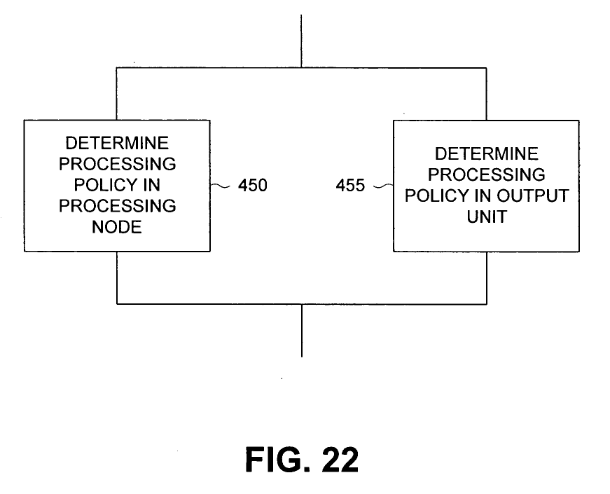

FIG. 24 is flow diagram that depicts one alternative example method for delivering an outbound work request to an output device. According to this alternative example method, an outbound work request is delivered to an output device by generating a work request indicator (step 485), selecting a work queue according to a determined processing policy (step 490) and placing the work request indicator in the selected work queue (step 495).

FIG. 19 further illustrates that, according to one variation of the present method, processing outbound data is accomplished by further determining an interrupt mechanism according to the determined processing policy (step 420). A processor is interrupted according to the determined interrupt mechanism (step 425). It should be appreciate that determining an interrupt mechanism for a quantum of outbound data is accomplished in an analogous manner to that of determining an interrupt mechanism for a quantum of inbound data. Any differences in determining an interrupt mechanism for an outbound quantum of data are further described below. It should, however, be appreciated that determining an interrupt mechanism for a quantum of outbound data comprises determining a priority level according to a quality-of-service indicator determined for a quantum of outbound data. Accordingly, a quality-of-service indicator is determined according to at least one of a node attribute, an output device attribute and a packet attribute.

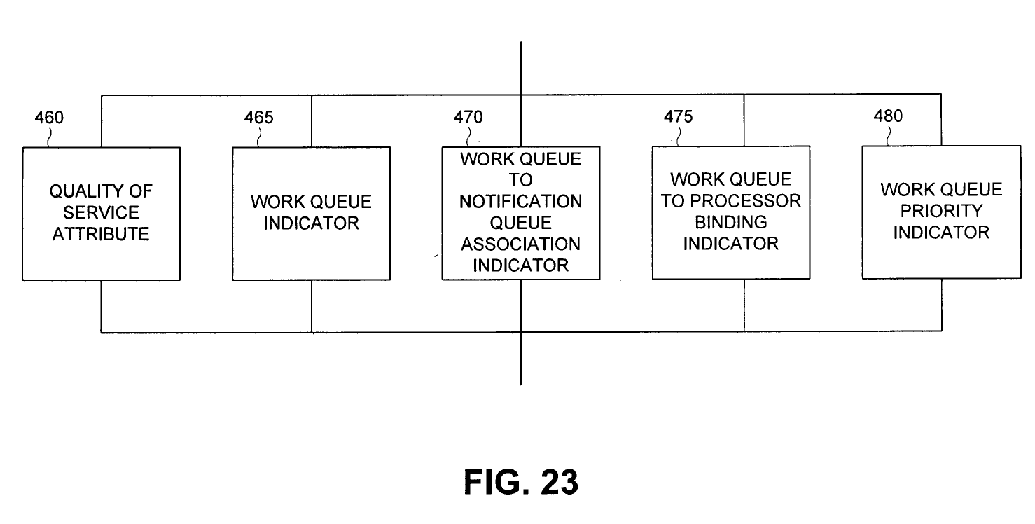

FIG. 25 is flow diagram that depicts one example variation of the present method for determining an interrupt mechanism for outbound data according to an in-band priority level indicator. According to this example variation of the present method, an in-band priority indicator is received in an output device (step 500). An interrupt priority level is then established according to the received priority indicator (step 505). An in-band priority level indicator, according to yet another variation of the present method, is received in a node processor, as heretofore described in methods pertaining to the processing of a quantum of inbound data.

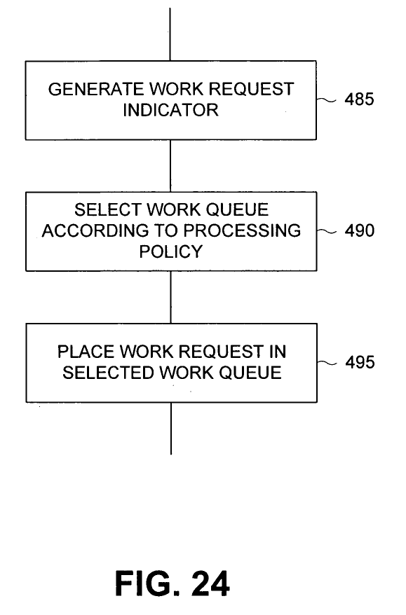

FIG. 26 is a flow diagram that depicts one alternative method for determining an interrupt mechanism based on a work queue. According to this example alternative variation of the present method, a priority level for a work queue is determined (step 510). The determined priority level is then used as a basis for establishing an interrupt priority level, which is then used to interrupt a processor (step 515).

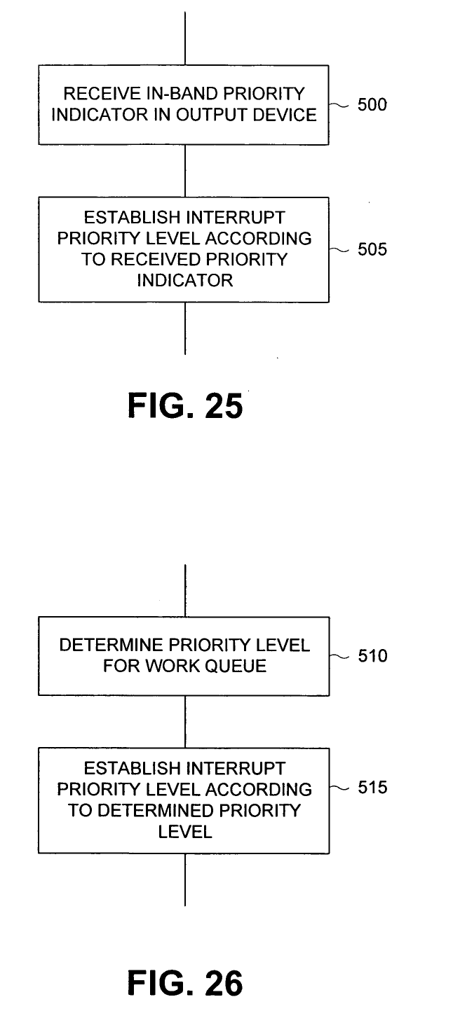

FIG. 27 is a flow diagram that depicts variations in the present method applicable to coalescing interrupts while processing a quantum of outbound data. According to one example variation of the present method (as depicted in FIG. 15), interrupting a processor comprises accumulating one or more interruptible events, determining a coalescence value and generating a processor interrupt when a quantity of interruptible events has reached the coalescence value. This alternative variation of the present method is much akin to a method for interrupting a processor that pertains to processing a quantum of inbound data. However, one example variation of the present method applicable to the processing of outbound data provides that determining a coalescence value is accomplished by establishing a count of link-level frames (step 520). In yet another example variation, determining a coalescence value for a quantum of outbound data is accomplished by establishing an interrupt latency time (step 525). In yet another alternative example variation of the present method, establishing a coalescence value that is used to govern the accumulation of interrupts while processing a quantum of outbound data is accomplished by establishing a dispatched segment count (step 530). In yet another example variation of the present method, a dispatched byte count is established as a coalescence value (step 535). The dispatched byte count is used to govern the generation of a processor interrupt according to this example variation of the present method.

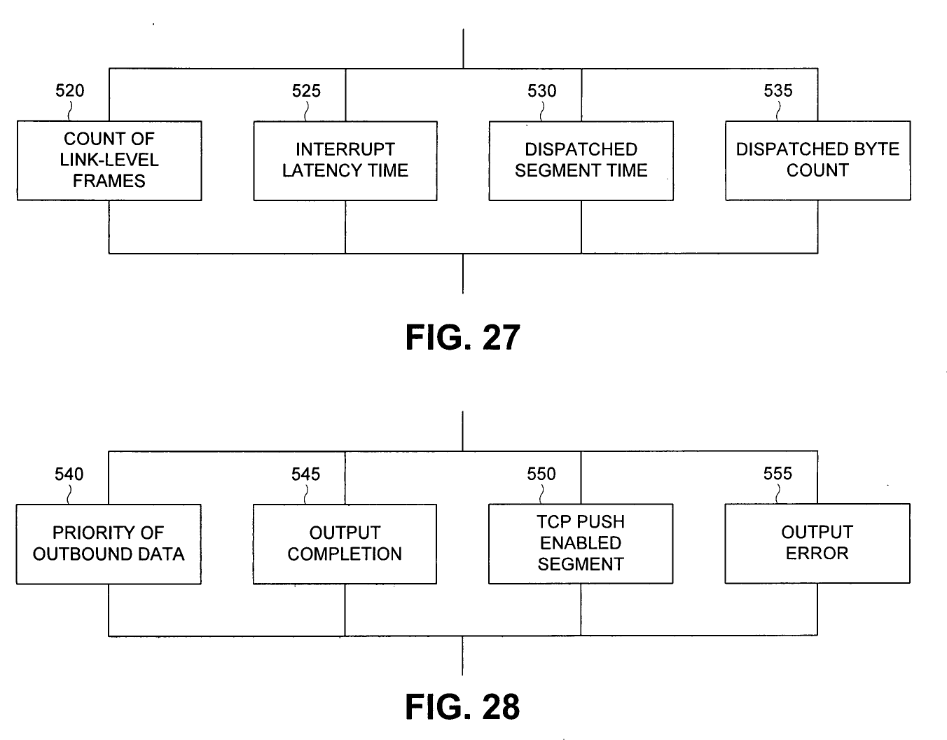

FIG. 28 is a flow diagram that depicts variations in the present method for defining an interruptible event that are applicable to the processing of a quantum of outbound data. According to one example variation of the present method, interrupting a processor comprises defining an interruptible event and interrupting a processor when the interruptible event occurs (see FIG. 17). According to yet another example variation of the present method, defining an interruptible event comprises defining a priority definition for a quantum of outbound data (step 540). In yet another example variation of the present method, an interruptible event is defined by defining an output completion event (step 545). In yet another example variation of the present method, defining an interruptible event comprises defining a TCP push enabled segment event (step 550). And in yet another example variation of the present method, an interruptible event is defined by defining an output error event as an interruptible event (step 555).

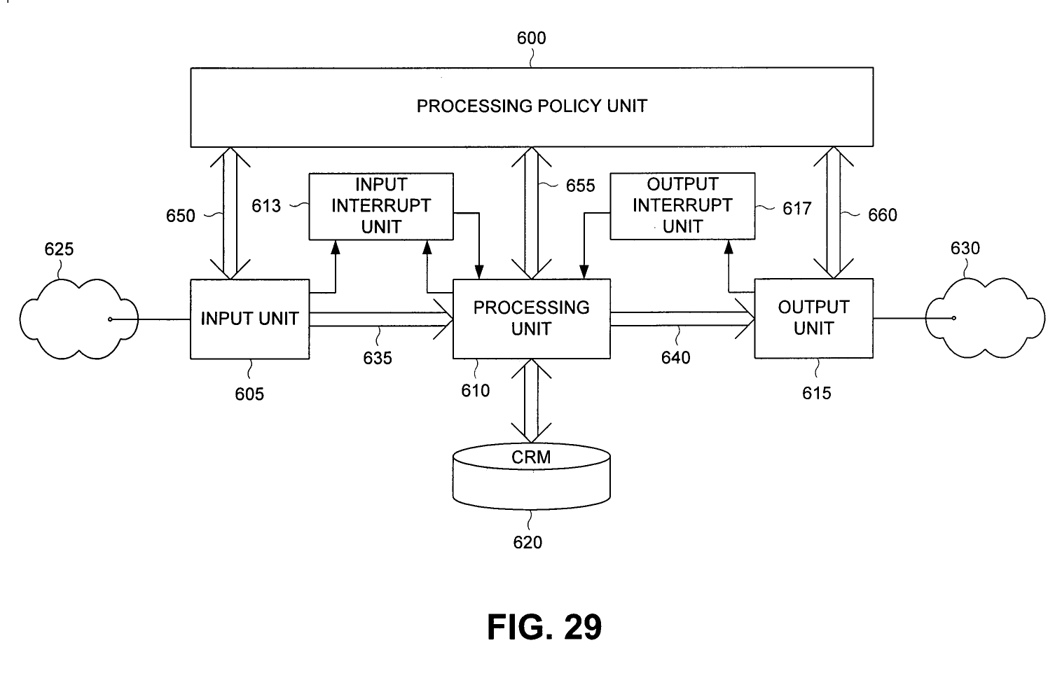

FIG. 29 is a block diagram that depicts one example embodiment of a system for processing inbound data. According to this example embodiment, a system for processing inbound data comprises a processing policy unit 600. The system further comprises an input unit 605. The system for processing inbound data further comprises a processing unit 610. According to this example embodiment, the processing policy unit 600 generates a processing policy signal for a quantum of inbound data. A quantum of inbound data is received according to the processing policy signal. It should further be appreciated that the processing policy signal is provided 650 to the input unit 605 and is also provided to the processing unit 610. In one alternative embodiment, the processing policy signal is also provided to an input interrupt unit 613, which is included in this alternative embodiment of a system for processing inbound data. In an alternative example embodiment that is tailored for processing a quantum of outbound data, the processing policy signal is provided to the processing unit and is also provided to an output unit. It should also be appreciated that the processing policy signal is also provided to an output interrupt unit 617, which is included in yet another alternative embodiment of a system for processing outbound data. According to yet another alternative embodiment, a system for processing inbound data further comprises a computer readable medium (CRM) 620. The computer readable medium 620, according to this alternative embodiment, is used to store a quantum of inbound data. In operation, the input unit 605 receives a quantum of data from an external communications medium 625, for example a computer data network medium.

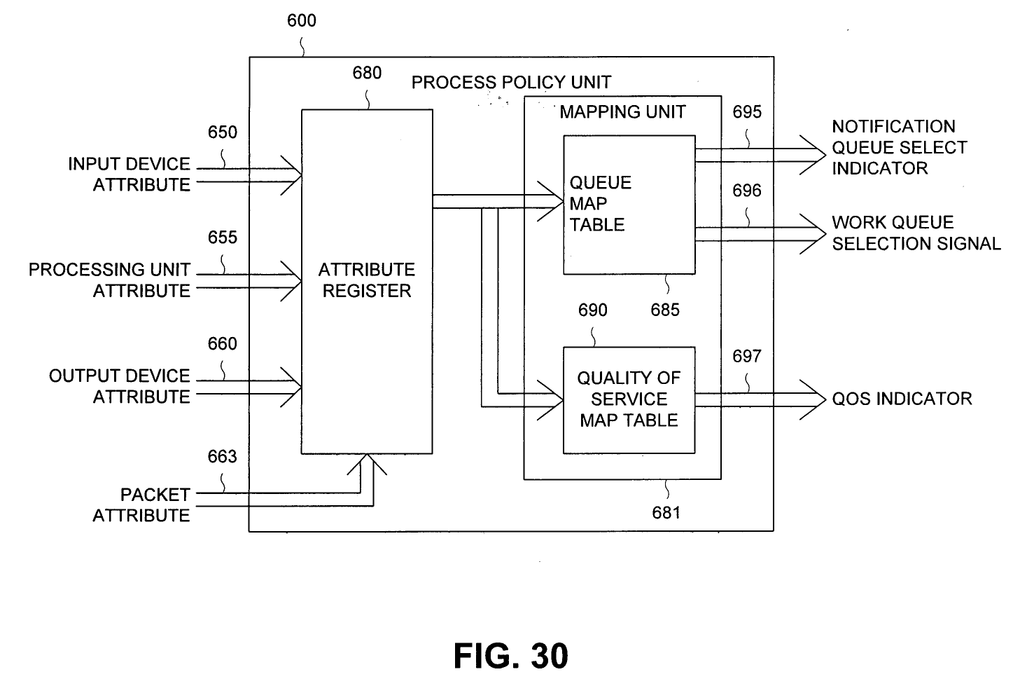

FIG. 30 is a block diagram that depicts several example alternative embodiments of a processing policy unit. According to one example alternative embodiment, a processing policy unit 600 comprises an attribute register 680 and a mapping unit 681. In one alternative embodiment, the mapping unit comprises a notification queue map table 685. In yet another alternative example embodiment, the mapping unit comprises a quality-of-service map table 690. According to one alternative embodiment, the attribute register 680 receives an input device attribute 650, which is typically received from the input unit 605. According to yet another alternative embodiment, the attribute register 680 receives a node attribute 655, which is typically received from the processing unit 610. It one alternative embodiment of a system suitable for processing outbound data, the processing policy unit 600 includes an attribute register 680 that receives an output device attribute 660. The output device attribute 660 is typically received from the output unit 615 included in a system for processing outbound data.

In any of the afore-described embodiments of a processing policy unit 600, an attribute stored in the attribute register 680 is directed to the mapping unit. Accordingly, it one alternative embodiment, an attribute stored in the attribute register 680 is directed to a queue map table 685. The queue map table 685 is used to store a correlation of a particular attribute to a particular input notification queue. Accordingly, the queue map table 685 is typically populated with empirical information, wherein such empirical information is derived by performance monitoring (and tuning) of a system employing a processing policy unit 600 as herein described. According to yet another alternative embodiment, an attribute stored in the actually register 680 is directed to a quality-of-service map table 690. The quality-of-service map table 690 is used to store empirical information that enables generation of a quality-of-service indicator 697 based on a particular attribute value, as stored in the attribute register 680. It should be appreciated that the information stored in the quality-of-service map table 690 is derived based on performance monitoring (and tuning) of a system that employs a processing policy unit 600 as described herein. Hence, the contents of the quality-of-service map table 690, according to one alternative embodiment, comprise empirical information which is used to generate a quality-of-service indicator 697 according to a particular attribute value.

According to various alternative example a embodiments, the attribute register 680 receives a node attribute that includes at least one of a queue quantity indicator, a queue scheduling scheme indicator, quantity of processors available for interrupt indicator, device bandwidth indicator, protocol off-load capabilities indicator, interrupt coalescing support indicator, input device memory resource indicator, data in-lining support indicator, variable length data support indicator, queue resource indicator and doorbell resource indicator. According to various alternative illustrative embodiments, the attribute register 680 receives 650 an input device attribute 650 that includes at least one of a queue quantity indicator, a queue scheduling scheme indicator, quantity of processors available for interrupt indicator, device bandwidth indicator, protocol off-load capabilities indicator, interrupt coalescing support indicator, input device memory resource indicator, data in-lining support indicator, support for variable length data in inbound data notifications indicator, queue resource indicator and doorbell resource indicator.

According to one example alternative embodiment, the attribute register 680 included in a processing policy unit 600 receives a packet attribute 663, which is typically received 650 from an input unit 605. In this alternative embodiment, the input unit 605 extracts information from an incoming data packet, which is typically, but not necessarily received from an external data network 625. According to various example alternative embodiments, the input unit 605 provides (and the attribute register 680 stores) a packet attribute 663 that includes at least one out of a quantity of data transferred indicator, a contents of a link header, a contents of a network header, a contents of a transport header, a grouping of packets indicator, a logical grouping of packets based on endpoint indicator, a logical grouping of packets based on multiple endpoints, a logical grouping of packets according to traffic type indicator, an in-band indicator of traffic type and an in-band indicator of quality of service.

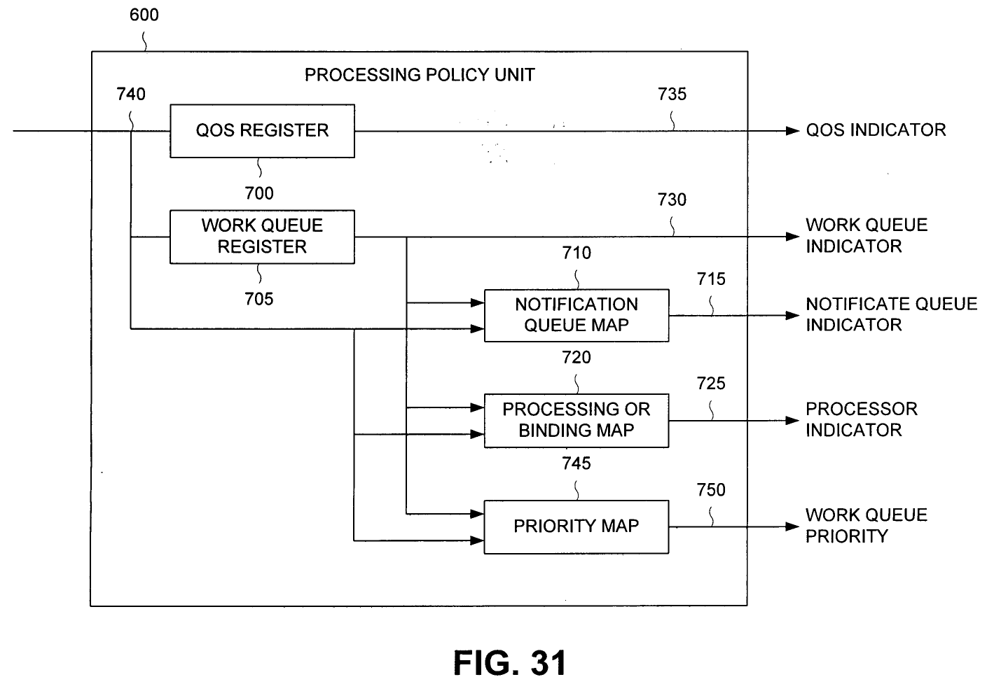

FIG. 31 is a block diagram that depicts one alternative example embodiment of a processing policy unit. According to this example alternative embodiment, a processing policy unit 600 comprises at least one of a quality-of-service register 700 and a work-queue register 705. According to one embodiment, the quality-of-service register 700 stores a quality-of-service indicator 735. The quality-of-service indicator is honored by at least one of the input unit 605 and a processing unit 610. In one alternative embodiment suitable for processing outbound data, the quality-of-service indicator 735 is provided to an output unit 615 (in lieu of the input unit), which honors the quality-of-service indicator when a quantum of outbound data is processed.

In yet another alternative example embodiment, the processing policy unit 600 includes at least one of a notification queue map 710, a processor binding map 720, and a priority map 745. In one alternative example embodiment that includes a notification queue map 710, the notification queue map 710 is used to store an empirical correlation of a notification queue based on a work queue indicator 730 provided by the work queue register 705. In this case, the notification queue map 710 generates a notification queue indicator 715, which is directed to at least one of the input unit 605, the processing unit 610 and, in embodiments that support processing of an outbound quantum of data, to an output unit 615 (again in lieu of the input unit).

In one example alternative embodiment that includes a processor binding map 720, the processor binding map 720 is used to store an empirical correlation of a processor indicator based on a work queue indicator 730 provided by the work queue register 705. Accordingly, the processor binding map 720 generates a processor indicator 725 according to a work queue indicator 730 received from the work queue register 705.

According to yet another alternative embodiment, the processing policy unit 600 further includes a priority map 745. The priority map 745 is configured using empirical information that correlates a particular work queue to a particular work queue priority. Accordingly, the priority map 745 receives a work queue indicator 730 from the work queue register 705 and generates a work queue priority indicator 750 according to the work queue indicator 730 received from the work queue register 705.

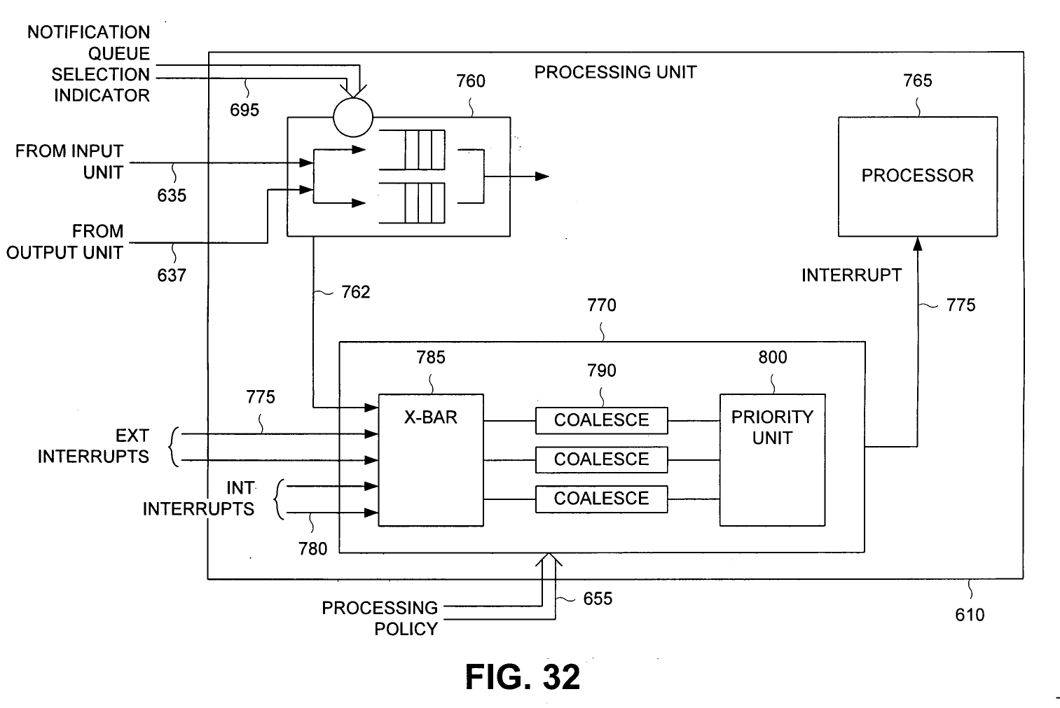

FIG. 32 is a block diagram that depicts several example alternative embodiments of a processing unit that honors a processing policy. According to one alternative example embodiment, a processing unit 610 includes a plurality of notification queues. The plurality of notification queues are included in a notification queue unit 760. When a quantum of input data 635 is received from the input unit 605, the processing unit 610 stores the quantum of input data 635 in a particular notification queue included in the notification queue unit 760. A particular notification queue is selected according to a notification queue select indicator 695 received from the processing policy unit 600. It should be appreciated that the processing policy unit 600 generates a notification queue selection indicator 695, at least according to one example alternative embodiment, by means of a queue map table 685 included in the processing policy unit 600.

According to yet another example alternative embodiment, a processing unit 610 further includes an interrupt controller 770. The interrupt controller 770 is configured according to a processing policy signal 655 generated by the processing policy unit 600. In one alternative example embodiment, the interrupt controller 770 is configured according to a processing policy signal 655 that comprises at least one of a priority level indicator and a quality-of-service indicator. Typically, a priority level indicator is generated by a processing policy unit 600 that includes a priority map 745 as described supra. It should be appreciated that the processing policy signal 655 is used to configure a particular interrupt channel which the interrupt controller 770 provides. For example, the interrupt controller 770, according to one alternative embodiment, includes a plurality of interrupt channels which are used to service external interrupts 775. External interrupts, according to one alternative embodiment, are received from the input unit 605. In yet another alternative example embodiment, external interrupts are received from the output unit 615. According yet another alternative example embodiment, the interrupt controller 770 includes a plurality of internal interrupt channels 780, which are used to service interrupts internal to the processing unit 610.

According to yet another example alternative embodiment, a system for processing inbound data further comprises an input interrupt unit 613 (FIG. 29). The input interrupt unit 613 monitors a quantum of inbound data received by the input unit 605. Based on the quantum of inbound data received by the input unit 605, the input interrupt unit 613 determines a priority level for a quantum of inbound data. This priority level is then incorporated into a processing policy which is then used to configure the interrupt controller 770 included in one alternative example embodiment of a processing unit 610. The input interrupt unit 613, according to one alternative embodiment, determines a priority level for a quantum of inbound data received in the processing unit 610. In this situation, the input interrupt unit 613 monitors the quantum of inbound data received by the processing unit 610 and determines a priority level for the quantum of inbound data. It should be appreciated that in either of these situations, the input interrupt unit 613 determines a priority level based on the content of a quantum of inbound data (i.e. in-band information).

FIG. 32 further illustrates that, according to yet another alternative example embodiment, the interrupt controller 770 further comprises a coalescence register 790. The coalescence register 790 is configured to accept a coalescence value. The coalescence register 790 accepts individual interrupt events, which according to one alternative embodiment arrive from a crossbar switch 785, and propagates an interrupt signal to the processor 765 when the coalescence value stored in the coalescence register 790 has been satisfied. It should be appreciated that the crossbar switch 785 is included in one example embodiment of a system for processing inbound data. In an embodiment that includes the crossbar switch, the crossbar switch is disposed to accept a plurality of interrupt signals from either external interrupt signals sources 775 or internal interrupt signal sources 780, relative to the boundary of the processing unit 610. The crossbar switch is configured according to configuration word that is accepted by the interrupt controller 770. In the case were the interrupt controller 770 does not include a crossbar switch 785, individual interrupt signals are wired directly to one or more coalescence registers 790. For example, according to one alternative embodiment, the coalescence register stores a count of link-level frames. In this case, an interrupt received at the crossbar switch 785 and directed to the coalescence register 790 corresponds to a received link-level frame. Once the number of link-level frame interrupts recognized by the coalescence register 790 is substantially equivalent to the coalescence value stored therein, the coalescence register 790 propagates an interrupt signal to the processor 765. It should be appreciated that, according to one alternative embodiment of an interrupt controller 770, the output of the coalescence register 790 is first processed by a priority unit 800, which is included in this alternative example embodiment of an interrupt controller 770. Again, it should be appreciated that the priority unit 800 is an optional element of an interrupt controller 770, at least according to this alternative example embodiment.

In yet another alternative example embodiment, the coalescence register 790 stores an interrupt latency time. In this case, the coalescence register 790 receives an interrupt signal from the crossbar switch 785. Once a particular interval of time, which corresponds to the stored interrupt latency time, has expired the coalescence register 790 propagates an interrupt signal 775 to the processor 765. According to yet another example alternative embodiment, the coalescence register 790 stores an arrived segment count. In this alternative example embodiment, an interrupt signal are received by the crossbar switch 785 corresponds to the arrival of a networking data segment. Accordingly, the coalescence register 790 propagates an interrupt signal 775 to the processor 765 once the number of interrupt events received from the crossbar switch 785 corresponding to an arrival of a networking data segment meets an arrived segment count stored in the coalescence register 790. In yet another example alternative embodiment, the coalescence register 790 stores an arrived byte count. In this alternative embodiment, an interrupt signal received by the crossbar switch 785 corresponds to the arrival of a byte of data. In this situation, the coalescence register 790 will propagates an interrupt signal 775 to the processor 765 once a quantity of interrupt signals corresponding to the arrival of a byte corresponds to an arrived by count stored in the coalescence register 790.

In one alternative example embodiment, the crossbar switch 785 accepts interrupt signals from at least one of an input completion detector, a TCP PUSH enabled segment detector, an input error detector, and arrived byte mask detector and an arrived header mask detector. Typically, such detectors are included in the input interrupt unit 613, which monitors an inbound quantum of data and is disposed to detect in-band data events.

FIG. 29 also illustrates several alternative example embodiments of a system for processing a quantum of outbound data. According to one example embodiment, a system for processing outbound data comprises a processing policy unit 600, a processing unit 610 and an output unit 615. According to this example alternative embodiment, the processing policy unit 600 generates a processing policy signal for a quantum of outbound data. In one alternative example embodiment, the processing policy signal is provided 655 to the processing unit 610. In yet another alternative example embodiment, the processing signal is provided 660 to the output unit 615. It should be appreciated that the processing unit 610 generates a quantum of outbound data. Generating a quantum of outbound data by the processing unit 610 comprises at least one of generating the data within the processing unit 610 or retrieving a quantum of data from computer readable medium 620. In either case, the quantum of outbound data is processed in accordance with an outbound data work request, which is generated for the quantum of outbound data. It should further be appreciated that the outbound data work request is generated according to the processing policy signal 655 received by the processing unit 610 from the processing policy unit 600. The output unit 615, at least according to one alternative example embodiment, dispatches the outbound data 640 according to the work request. The operation of the output unit 615 is further controlled according to the processing policy signal 660 it receives from the processing policy unit 600. It should be appreciated that, according to one alternative embodiment, the processing policy unit 600 is included in the processing unit 610. According to yet another alternative example embodiment, the processing policy unit 600 is included in the output unit 615. In yet another embodiment, the processing policy unit 600 in included in a processing unit 610. An in yet another alternative embodiment, the processing policy unit 600 comprises a stand-alone module with a compute node.

FIG. 30 further illustrates one alternative example embodiment of a processing policy unit 600 that includes an attribute register 680 which is used to store a node attribute. This alternative example embodiment of a processing policy unit 600 includes a queue map table 685 that generates a work queue selection signal 696 based on a processing unit attribute 655 stored in the attribute register 680. It should be appreciated that the queue map table 685 is typically populated with information that correlates a particular work queue selection signal to a particular value of a processing unit attribute stored in the attribute register 680. The attribute register, according to various alternative example embodiments, stores a processing unit attribute that includes, but is not limited to at least one of a processor task assignment indicator, a process priority indicator, output device location indicator, quantity of processors indicator, quantity of processors assigned to output device indicator, quantity processors allowed for interrupt indicator, multi-priority interrupts allowed indicator, and memory accessed by task indicator. It should likewise be appreciated that, according to yet another alternative example embodiment, the processing policy unit 600 includes a quality-of-service map table 690, which is used to generate a quality-of-service indicator 697 according to the attribute value stored in the attribute register 680. It should also be appreciated that the quality-of-service map table 690 is populated with information that correlates a particular quality-of-service indicator with a particular value of a node attribute 665.

According to yet another alternative example embodiment, the processing policy unit 600 includes an attribute register 680 that is used to store an output unit attribute 660. According to several other example alternative embodiments, the attribute register 680 stores at least one of a queue quantity indicator, a queue scheduling scheme indicator, quantity of processors available for interrupt indicator, device bandwidth indicator, protocol off-load capabilities indicator, interrupt coalescing support indicator, output device memory resource indicator, data in-lining support indicator, support for variable length data in outbound data notifications indicator and a queue resource indicator. A queue map table 685 included in one alternative example embodiment generates a work at selection signal 696 according to an output device attribute 660 stored in the attribute register 680. A quality-of-service map table 690 included in one alternative example embodiment generates a quality-of-service indicator of according to an output device attribute 660 stored in the attribute register 680.

In yet another example alternative embodiment, the processing policy unit 600 includes it attribute register 680 that stores a packet attribute 663. The packet attribute 663 is received from at least one of the processing unit 610 and the output unit 615. The packet attribute 663 represents in-band information that is used by this alternative example embodiment of a processing policy unit 600 to generate at least one of a work queue selection signal 696 and quality-of-service indicator 697. According to several example alternative embodiments, the attribute register 680 stores a packet attribute 663 that includes, but is not limited to at least one of a quantity of data transferred indicator, a contents of a link header, a contents of a network header, a contents of a transport header, a grouping of packets indicator, a logical grouping of packets based on endpoint indicator, a logical grouping of packets based on multiple endpoints, a logical grouping of packets according to traffic type indicator, an in-band indicator of traffic type and an in-band indicator of quality-of-service.

FIG. 31 further illustrates that according to one example alternative embodiment, the processing policy unit 600 included in a system for processing a quantum of outbound data includes at least one of a quality-of-service register 700 and a work queue register 705. It should be appreciated that the quality-of-service register 700 and the work queue register 705 operate in a like manner to their counterparts included in the processing policy unit 600 included in a system for processing a quantum of inbound data, supra. According to one alternative example embodiment, the processing policy unit 600 included in a system of processing a quantum of outbound data includes at least one of a notification queue map 710, a processor binding map 720 and a priority map 745. It should be appreciated that each of these alternative elements operate in a like manner vis-à-vis their counterparts included in a processing policy unit 600 that is included in a system for processing a quantum of inbound data as described a supra.

FIG. 32 further illustrates that, according to one example alternative embodiment, the processing unit 610 included in a system for processing a quantum of outbound data includes a notification queue unit 760. The notification queue unit 760 operates in a like manner to the notification queue unit described above and included in a processing unit 610 included in a system for processing a quantum of inbound data. However, the notification queue unit 760 included in the processing unit 610 included in a system for processing a quantum of outbound data receives a notification indicator 637 from the output unit 615.

FIG. 32 also illustrates that, according to one example alternative embodiment, the processing unit 610 included in a system for processing a quantum of outbound data includes an interrupt controller 770. The interrupt controller 770 included in a system for processing a quantum of outbound data is fashion like the interrupt controller included in a system for processing a quantum of inbound data described supra. There are, however, some subtle differences. For example, according to one alternative embodiment, the coalescence register 790 stores a transmitted segment count rather than an arrived segment count. In another example alternative embodiment, the coalescence register 790 stores a transmitted byte count rather than an arrived byte count. The interrupt controller 770 included in a system for processing a quantum of outbound data includes a crossbar switch 785 that is connected to at least one of an output completion signal, a TCP PUSH Enabled Segment signal, an output error signal, a transmitted byte mask signal and a transmitted header mask signal. Aside from these few differences, the interrupt controller 770 included a processing unit 610 included in a system for processing a quantum of outbound data functions identically to an interrupt controller 770 included in the processing unit 610 included in a system for processing a quantum of inbound data.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for processing inbound data comprising:
determining a processing policy for a quantum of inbound data;
receiving a quantum of inbound data;
preparing an inbound data notification for the inbound data; and
delivering the inbound data notification to a processor according to the processing policy.

2. The method of claim 1 wherein determining a processing policy comprises:
receiving a node attribute; and
determining at least one of a notification queue and a quality-of-service attribute according to the node attribute.

3. The method of claim 2 wherein receiving a node attribute comprises receiving at least one of a processor task assignment, a process priority indicator, input device location indicator, quantity of processors indicator, quantity of processors assigned to input device indicator, quantity of processors allowed for interrupt indicator, multi-priority interrupts allowed indicator, and memory accessed by task indicator.

4. The method of claim 1 wherein determining a processing policy comprises:
receiving a input device attribute; and
determining at least one of a notification queue and a quality-of-service attribute according to the input device attribute.

5. The method of claim 4 wherein receiving a input device attribute comprises receiving at least one of a queue quantity indicator, a queue scheduling scheme indicator, quantity of processors available for interrupt indicator, device bandwidth indicator, protocol off-load capabilities indicator, interrupt coalescing support indicator, input device memory resource indicator, data in-lining support indicator, support for variable length data in inbound data notifications indicator, queue resource indicator and doorbell resource indicator.

6. The method of claim 1 wherein determining a processing policy comprises:
receiving a packet attribute; and
determining at least one of a notification queue and a quality-of-service attribute according to the packet attribute.

7. The method of claim 6 wherein receiving a packet attribute comprises receiving at least one of a quantity of data transferred indicator, a contents of a link header, a contents of a network header, a contents of a transport header, a grouping of packets indicator, a logical grouping of packets based on endpoint indicator, a logical grouping of packets based on multiple endpoints, a logical grouping of packets according to traffic type indicator, an in-band indicator of traffic type and an in-band indicator of quality of service.

8. The method of claim 1 wherein determining a processing policy comprises determining a processing policy in at least one of an input device and a processing unit.

9. The method of claim 1 wherein determining a processing policy comprises receiving a policy function that includes at least one of a quality-of-service attribute, notification queue indicator, work queue to notification queue association indicator, a notification queue to processor binding indicator, a notification queue priority indicator,

10. The method of claim 1 wherein delivering the inbound data notification to a processor comprises:
generating a notification indicator;
selecting a notification queue according to a processing policy; and
placing the notification indicator in the selected notification queue.

11. The method of claim 1 further comprising:
determining an interrupt mechanism according to the determined processing policy; and
interrupting a processor according to the determined interrupt mechanism.

12. The method of claim 11 wherein determining an interrupt mechanism comprises determining a priority level according to a quality-of-service indicator determined according to at least one of a node attribute, an input device attribute and a packet attribute.

13. The method of claim 11 wherein determining an interrupt mechanism comprises:
receiving in-band priority level indicator in an input device; and
establishing an interrupt priority level according to the in-band priority level indicator.

14. The method of claim 11 wherein determining an interrupt mechanism comprises:
receiving in-band priority level indicator in a node processor; and
establishing an interrupt priority level according to the in-band priority level indicator.

15. The method of claim 11 wherein determining an interrupt mechanism comprises:
determining a priority level for a notification queue; and
establishing an interrupt priority level according to the determined priority level.

16. The method of claim 11 wherein interrupting a processor comprises:
accumulating one or more interruptible events;
determining a coalescence value; and
generating a processor interrupt when a quantity of interruptible events has reached the coalescence value.

17. The method of claim 16 wherein determining a coalescence value comprises at least one of establishing a count of link-level frames, establishing an interrupt latency time, establishing an arrived segment count, and establishing an arrived byte count.

18. The method of claim 11 wherein interrupting a processor comprises:
defining an interruptible event; and
interrupting the processor when the interruptible event occurs.

19. The method of claim 18 wherein defining an interruptible event comprises at least one of defining a priority definition for a quantum of inbound data, defining a input completion event, defining a TCP PUSH Enabled segment event, defining an input error event, defining an arrived byte mask event and defining an arrived header mask event.

20. A method for processing outbound data comprising:
determining a processing policy for a quantum of outbound data;
selecting a quantum of outbound data;
preparing an outbound data work request for the outbound data; and
delivering the work request to an output unit according to the processing policy.

21. The method of claim 20 wherein determining a processing policy comprises:
receiving a node attribute; and
determining at least one of a work queue and a quality-of-service attribute according to the node attribute.

22. The method of claim 21 wherein receiving a node attribute comprises receiving at least one of a processor task assignment, a process priority indicator, output device location indicator, quantity of processors indicator, quantity of processors assigned to output device indicator, quantity of processors allowed for interrupt indicator, multi-priority interrupts allowed indicator, and memory accessed by task indicator.

23. The method of claim 20 wherein determining a processing policy comprises:
receiving an output device attribute; and
determining at least one of a work queue and a quality-of-service attribute according to the output device attribute.

24. The method of claim 23 wherein receiving an output device attribute comprises receiving at least one of a queue quantity indicator, a queue scheduling scheme indicator, quantity of processors available for interrupt indicator, device bandwidth indicator, protocol off-load capabilities indicator, interrupt coalescing support indicator, output device memory resource indicator, data in-lining support indicator, support for variable length data in outbound completions indicator and a queue resource indicator.

25. The method of claim 20 wherein determining a processing policy comprises:
receiving a packet attribute; and
determining at least one of a work queue and a quality-of-service attribute according to the packet attribute.

26. The method of claim 25 wherein receiving a packet attribute comprises receiving at least one of a quantity of data transferred indicator, a contents of a link header, a contents of a network header, a contents of a transport header, a grouping of packets indicator, a logical grouping of packets based on endpoint indicator, a logical grouping of packets based on multiple endpoints, a logical grouping of packets according to traffic type indicator, an in-band indicator of traffic type and an in-band indicator of quality of service.

27. The method of claim 20 wherein determining a processing policy comprises determining a processing policy in at least one of an output device and a processing node.

28. The method of claim 20 wherein determining a processing policy comprises receiving a policy function that includes at least one of a quality-of-service attribute, work queue indicator, work queue to notification queue association indicator, a work queue to processor binding indicator and a work queue priority indicator.

29. The method of claim 20 wherein delivering the outbound work request to an output device comprises:
generating a work request indicator;
selecting a work queue according to a processing policy; and
placing the work request indicator in the selected work queue.

30. The method of claim 20 further comprising:
determining an interrupt mechanism according to the determined processing policy; and
interrupting a processor according to the determined interrupt mechanism.

31. The method of claim 30 wherein determining an interrupt mechanism comprises determining a priority level according to a quality-of-service indicator determined according to at least one of a node attribute, an output device attribute and a packet attribute.

32. The method of claim 30 wherein determining an interrupt mechanism comprises:
receiving an in-band priority level indicator in an output device; and
establishing an interrupt priority level according to the in-band priority level indicator.

33. The method of claim 30 wherein determining an interrupt mechanism comprises:
receiving in-band priority level indicator in a node processor; and
establishing an interrupt priority level according to the in-band priority level indicator.

34. The method of claim 30 wherein determining an interrupt mechanism comprises:
determining a priority level for a work queue; and
establishing an interrupt priority level according to the determined priority level.

35. The method of claim 30 wherein interrupting a processor comprises:
accumulating one or more interruptible events;
determining a coalescence value; and
generating a processor interrupt when a quantity of interruptible events has reached the coalescence value.

36. The method of claim 35 wherein determining a coalescence value comprises at least one of establishing a count of link-level frames, establishing an interrupt latency time, establishing a dispatched segment count, and establishing a dispatched byte count.

37. The method of claim 30 wherein interrupting a processor comprises:
defining an interruptible event; and
interrupting the processor when the interruptible event occurs.

38. The method of claim 37 wherein defining an interruptible event comprises at least one of defining a priority definition for a quantum of outbound data, defining an output completion event, defining a TCP PUSH Enabled segment event and defining an output error event.

39. A system for processing inbound data comprising:
processing policy unit capable of generating a processing policy signal for a quantum of inbound data;
input unit capable of receiving a quantum of inbound data and generating an inbound data notification signal according to a received quantum of inbound data wherein the quantum of input data is received and the data notification is generated according to the processing policy signal; and
processing unit capable of receiving from the input unit a quantum of inbound data according to the policy signal.

40. The system of claim 39 wherein the processing policy unit comprises:
attribute register capable of storing a node attribute; and
mapping unit capable of generating at least one of a notification queue selection signal and a quality-of-service signal according to a node attribute stored in the attribute register.

41. The system of claim 40 wherein the attribute register is capable of storing at least one of a processor task assignment indicator, a process priority indicator, input device location indicator, quantity of processors indicator, quantity of processors assigned to input device indicator, quantity of processors allowed for interrupt indicator, multi-priority interrupts allowed indicator, and memory accessed by task indicator.

42. The system of claim 39 wherein the processing policy unit comprises:
attribute register capable of storing an input unit attribute; and
mapping unit capable of generating at least one of a notification queue selection signal and a quality-of-service signal according to an input unit attribute stored in the attribute register.

43. The system of claim 42 wherein the attribute register is capable of storing at least one of a queue quantity indicator, a queue scheduling scheme indicator, quantity of processors available for interrupt indicator, device bandwidth indicator, protocol off-load capabilities indicator, interrupt coalescing support indicator, input device memory resource indicator, data in-lining support indicator, variable length data in inbound notifications support indicator, queue resource indicator and doorbell resource indicator.

44. The system of claim 39 wherein the processing policy unit comprises:
attribute register capable of storing a packet attribute; and
mapping unit capable of generating at least one of a notification queue selection signal and a quality-of-service signal according to a packet attribute stored in the attribute register.

45. The system of claim 44 wherein the attribute register is capable of storing at least one of a quantity of data transferred indicator, a contents of a link header, a contents of a network header, a contents of a transport header, a grouping of packets indicator, a logical grouping of packets based on endpoint indicator, a logical grouping of packets based on multiple endpoints, a logical grouping of packets according to traffic type indicator, an in-band indicator of traffic type and an in-band indicator of quality of service.

46. The system of claim 39 wherein the processing policy unit is included in at least one of the input unit and the processing unit.

47. The system of claim 39 wherein the processing policy unit comprises at least one of a quality-of-service register capable of storing a quality-of-service indicator and a notification-queue register capable of storing a notification queue indicator.

48. The system of claim 39 wherein the processing policy unit comprises a notification-queue register capable of storing a notification queue indicator and further comprising at least one of a notification queue map capable of generating a notification queue indicator according to a notification queue indicator stored in the notification queue register, a processor binding map capable of generating a processor indicator according to a notification queue indicator stored in the notification queue register and a priority map capable of generating a priority indicator according to a notification queue indicator stored in the notification queue register.

49. The system of claim 39 wherein the processing unit comprises a notification queue unit that includes a plurality of notification queues and wherein the notification queue unit directs a notification indicator received from the input unit into a particular notification queue according to a notification queue select indicator generated by the processing policy unit.

50. The system of claim 39 wherein the processing unit comprises an interrupt controller that is configured according to the processing policy signal generated by the processing policy unit.

51. The system of claim 50 wherein the interrupt controller is configured according to a processing policy signal that comprises at least one of a priority level indicator and a quality-of-service indicator.

52. The system of claim 50 further comprising an input interrupt unit capable of determining a priority level according to a quantum of inbound data and wherein the interrupt controller is configured according to the determined priority level.

53. The system of claim 50 wherein the interrupt controller comprises:
interrupt channel capable of interrupting a processor; and
coalescence register capable of receiving a coalescence value and wherein the interrupt channel interrupts the processor when the coalescence value has been satisfied.

54. The system of claim 53 wherein the coalescence register stores at least one of a count of link-level frames, an interrupt latency time, an arrived segment count, and an arrived byte count.

55. The system of claim 50 wherein the interrupt controller comprises:
cross-bar switch disposed to accept a plurality of interrupt signals; and
configuration register capable of storing a configuration word where the cross-bar switch selectively enables an interrupt signal to an interrupt channel according to a value stored in the configuration register.

56. The system of claim 55 wherein the cross-bar switch is connected to at least one of an input completion signal, a TCP PUSH Enabled Segment signal, an input error signal, an arrived byte mask signal and an arrived header mask signal.

57. A system for processing outbound data comprising:
processing policy unit capable of generating a processing policy signal for a quantum of outbound data;
processing unit capable of generating a quantum of outbound data and also capable of generating an outbound data work request for the quantum of outbound data according to the processing policy; and
output unit capable of dispatching the outbound data according to the work request and also according to the processing policy signal.

58. The system of claim 57 wherein the processing policy unit comprises:
attribute register capable of storing a node attribute; and
mapping unit capable of generating at least one of a work queue selection signal and a quality-of-service signal according to a node attribute stored in the attribute register.

59. The system of claim 58 wherein the attribute register is capable of storing at least one of a processor task assignment indicator, a process priority indicator, output device location indicator, quantity of processors indicator, quantity of processors assigned to output device indicator, quantity of processors allowed for interrupt indicator, multi-priority interrupts allowed indicator, and memory accessed by task indicator.

60. The system of claim 57 wherein the processing policy unit comprises:
attribute register capable of storing an output unit attribute; and
mapping unit capable of generating at least one of a work queue selection signal and a quality-of-service signal according to an output unit attribute stored in the attribute register.

61. The system of claim 60 wherein the attribute register is capable of storing at least one of a queue quantity indicator, a queue scheduling scheme indicator, quantity of processors available for interrupt indicator, device bandwidth indicator, protocol off-load capabilities indicator, interrupt coalescing support indicator, output device memory resource indicator, data in-lining support indicator, variable length data in outbound completions support indicator and a queue resource indicator.

62. The system of claim 57 wherein the processing policy unit comprises:
attribute register capable of storing a packet attribute; and
mapping unit capable of generating at least one of a work queue selection signal and a quality-of-service signal according to a packet attribute stored in the attribute register.

63. The system of claim 62 wherein the attribute register is capable of storing at least one of a quantity of data transferred indicator, a contents of a link header, a contents of a network header, a contents of a transport header, a grouping of packets indicator, a logical grouping of packets based on endpoint indicator, a logical grouping of packets based on multiple endpoints, a logical grouping of packets according to traffic type indicator, an in-band indicator of traffic type and an in-band indicator of quality-of-service.

64. The system of claim 57 wherein the processing policy unit is included in at least one of the output unit and the processing unit.

65. The system of claim 57 wherein the processing policy unit comprises at least one of a quality-of-service register capable of storing a quality-of-service indicator and a work-queue register capable of storing a work queue indicator.

66. The system of claim 57 wherein the processing policy unit further comprises a work-queue register capable of storing a work queue indicator and further comprising at least one of a notification queue map capable of generating a notification queue indicator according to a work queue indicator stored in the work queue register, a processor binding map capable of generating a processor indicator according to a work queue indicator stored in the work queue register and a priority map capable of generating a priority indicator according to a work queue indicator stored in the work queue register.

67. The system of claim 57 wherein the processing unit comprises a notification queue unit that includes a plurality of notification queues and wherein the notification queue unit directs a notification indicator received from the output unit into a particular notification queue according to a notification queue select indicator generated by the processing policy unit.

68. The system of claim 57 wherein the processing unit comprises an interrupt controller that is configured according to the processing policy signal generated by the processing policy unit.

69. The system of claim 68 wherein the interrupt controller is configured according to a processing policy signal that comprises at least one of a priority level indicator and a quality-of-service indicator.

70. The system of claim 68 further comprising an output interrupt unit capable of determining a priority level according to a quantum of outbound data and wherein the interrupt controller is configured according to the determined priority level.

71. The system of claim 68 wherein the interrupt controller comprises:
interrupt channel capable of interrupting a processor; and
coalescence register capable of receiving a coalescence value and wherein the interrupt channel interrupts the processor when the coalescence value has been satisfied.

72. The system of claim 71 wherein the coalescence register stores at least one of a count of link-level frames, an interrupt latency time, a transmitted segment count, and a transmitted byte count.

73. The system of claim 68 wherein the interrupt controller comprises:
cross-bar switch disposed to accept a plurality of interrupt signals; and
configuration register capable of storing a configuration word where the cross-bar switch selectively enables an interrupt signal to an interrupt channel according to a stored configuration register.

74. The system of claim 73 wherein the cross-bar switch is connected to at least one of an output completion signal, a TCP PUSH Enabled Segment signal, an output error signal, a transmitted byte mask signal and a transmitted header mask signal.
